(19) United States
(12) Patent Application Publication
(10) Pub. No.: US 2008/0167824 A1
(43) Pub. Date: Jul. 10, 2008

(54) Systems and methods for sequencing carbohydrates

(75) Inventors: Vernon N. Reinhold, Lee, NH (US); Anthony J. Lapadula, Hampstead, NH (US); David J. Ashline, Lee, NH (US); Hailong Zhang, Nottingham, NH (US)

Correspondence Address: ROPES & GRAY LLP, PATENT DOCKETING 39/41, ONE INTERNATIONAL PLACE, BOSTON, MA, 02110-2624, US

(73) Assignee: University of New Hampshire, Durham, NH (US)

(21) Appl. No.: 11/899,395

(22) Filed: Sep. 4, 2007

Related U.S. Application Data
(60) Provisional application No. 60/959,266, filed on Jul. 11, 2007.
(60) Provisional application No. 60/841,803, filed on Sep. 1, 2006.

(51) Int. Cl. G01N 31/00

(52) U.S. Cl. 702/27

(57) ABSTRACT

In many aspects, the systems and methods of the invention are directed to sequencing of carbohydrates by mass spectrometry using computational approaches. The systems and methods utilize data derived from sequential mass spectrometry, in which a carbohydrate is fragmented to form products, each of which may then be fragmented further, gradually disassembling the carbohydrate. The systems and methods according to the principles of the invention resolve the tree-like structure of the original carbohydrate by examining the different ways in which disassembly occurs and then applying a set of inference rules that are at least based on mathematical constraints imposed on such tree-like structures.

### CROSS-REFERENCE TO RELATED APPLICATIONS

This application claims priority to and the benefit of U.S. Provisional Patent Application Ser. No. 60/959,266, filed Jul. 11, 2007, and U.S. Provisional Patent Application Ser. No. 60/841,803, filed Sep. 1, 2006, the entire contents of each of which are incorporated herein by reference.

### GOVERNMENT CONTRACT

The U.S. Government has a paid-up license in this invention and the right in limited circumstances to require the patent owner to license others on reasonable terms as provided for by the terms of Contract No. NCRR BRIN P20 RR16459 and NIGMS R01 GM54045 awarded by the National Institutes of Health.

### FIELD OF THE INVENTION

The invention is directed to systems and methods for sequencing of carbohydrates by mass spectrometry using computational approaches.

### BACKGROUND OF THE INVENTION

An oligosaccharide is generally a type of carbohydrate that contains a small number of simple sugars, also known as monosaccharides. Oligosaccharides are often found either O- or N-linked to compatible amino acid side chains in proteins or to lipid moieties. They are also often found as a component of glycoproteins or glycolipids and these are typically known as glycans. Glycans are key in many basic cellular functions and biological recognition events. For example, glycans are known to play an important role in some or all stages of tumor progression such as tumor growth and proliferation, angiogenesis, as well as tumor immunological defiance.

A substantially complete description of a glycan or any carbohydrate sequence typically provides the components of structure necessary for reporting or synthesis. Changes or alterations in glycan structure are known to accompany a number of pathological events associated with cancer. An understanding of such structural alterations can be used to detect cancerous cells or tumor growth at early stages. Structure determination of glycans is a challenging analytical problem that requires an understanding of isobaric structures that include inter-residue linkage, monomer identification, anomer configuration, and branching.

Sequential mass spectrometry (MSn) provides an opportunity to identify various structural components unobserved in the single stage MS experiment, by disassembling larger structures into sets of smaller fragments. A scientist using MSn can typically select a group of ions with similar mass-to-charge ratio (m/z) in the spectrum, fragment those ions, and measure the m/z of the generated product ion fragments. The process can be repeated, with the product ions from one step being selected and fragmented to reveal further internal detail. By following selective disassembly, product fragments can be generated that expose the most difficult features of isomeric structures.

In conventional approaches for extracting structural information about carbohydrates from MSⁿ data, spectral characteristics of the structure are compared against known oligosaccharide fragments, using literature-derived or biosynthetic constraints of the candidate structures to limit the number of computed solutions. In the catalog library method, a catalog contains the characteristic fragmentation patterns of substructures isolated from a library of known oligosaccharides. Total structure assignment is accomplished by matching observed fragmentation patterns with the catalog motif entries. The biosynthetic method uses simulated spectra. Because of the large number of possible fragments, computing these matching algorithms tends to be a slow process, even when using powerful computers. Moreover, the obtained solutions are often ambiguous and require human intervention for further refinement. A more detailed analysis of various approaches for extracting structural information about carbohydrates is presented in “A Software Suite for Assigning Glycan Topologies from Sequential Mass Spectral Data,” Anthony Lapadula, PhD Thesis, University of New Hampshire, 2007 (hereafter, “Lapadula PhD Thesis”), which is incorporated herein by reference in its entirety.

Accordingly, there is a need for more refined algorithms for assigning structural details from MSⁿ data in carbohydrate sequencing by mass spectrometry, and more particularly for a method that converges rapidly to a single solution for the carbohydrate structure, with less need for human intervention.

Access to rapid and reliable oligosaccharide sequencing tools may provide access to a detailed picture of the structure-function relationship for carbohydrates and insight into the functional biology of carbohydrates, including the identification of carbohydrates involved in key signal-transduction events. Further, there are currently a limited number of carbohydrate-based vaccines and a reliable, automated sequencing tool may allow further oligosaccharide antigens to be identified and characterized.

### SUMMARY OF THE INVENTION

The systems and methods of the invention are directed to sequencing of carbohydrates by mass spectrometry using computational approaches. The systems and methods utilize data derived from sequential mass spectrometry, in which a carbohydrate is fragmented to form products, each of which may then be fragmented further, gradually disassembling the carbohydrate. The systems and methods according to the principles of the invention resolve the tree-like structure of the original carbohydrate by examining the different ways in which disassembly occurs and then applying a set of inference rules that are at least based on mathematical constraints imposed on such tree-like structures. As noted earlier, an understanding of the structure and structural alterations can be used to detect cancerous cells or tumor growth at early stages. Such an application is described in more detail in “Uncovering Unique N-Linked Glycan Structural Isomers in Cancer via MSⁿ Disassembly,” Justin M. Prien, PhD. Thesis, University of New Hampshire, 2007, which is incorporated herein by reference in its entirety.

In one aspect the systems and methods described herein include methods for determining structural information about an oligosaccharide. The methods comprise providing a set of one or more monosaccharide units that make up at least a portion of the oligosaccharide, and populating at least one data structure for the one or more monosaccharide units, wherein the at least one data structure includes at least one data field containing sequence information for the one or more monosaccharide unit. The methods further include iteratively, applying an inference rule to the set of one or more monosaccharide units, and updating the at least one data structure by modifying the sequence information in the at least one data field based, at least in part, on an inference deduced from applying the inference rule. In certain embodiments the methods include determining structural information about the oligosaccharide from the updated data structure.

In certain embodiments, providing a set of one or more monosaccharide units comprises providing a first mass spectral data set obtained from profiling a sample comprising the oligosaccharide by mass spectrometry, selecting a first ion mass from the first mass spectral data set, and mapping the first ion mass to a first set of one or more monosaccharide units, wherein the combined mass of the monosaccharide units in the first set when joined together is consistent with the first ion mass. In such embodiments, the methods further include providing a second mass spectral data set obtained from profiling an ion indicated in the first mass spectral data set in a mass spectrometer, selecting a second ion mass from the second mass spectral data set, and mapping the second ion to a second set of one or more monosaccharide units, wherein the combined mass of the monosaccharide units in the first set when joined together is consistent with the second ion mass. The methods may further comprise comparing the second set of one or more monosaccharide units with the first set of one or more monosaccharide units to determine whether all monosaccharide units in the second set are also present in the first set. In certain embodiments, methods further comprise storing in memory both the first ion mass and the second ion mass. The methods may further comprise discarding the second set if it includes monosaccharide units not present in the first set.

In certain embodiments, providing a set of one or more monosaccharide units includes providing a plurality of mass spectral data sets obtained from profiling the oligosaccharide in a mass spectrometer and iteratively profiling individual ions detected during profiling, such that in each iteration a fragment of the oligosaccharide is individually profiled, selecting a plurality of ion masses from the mass spectral data sets, and mapping each ion mass to a set of one or more monosaccharide units, wherein the combined mass of the monosaccharide units when joined to form an oligosaccharide is consistent with the corresponding ion mass of the oligosaccharide. The methods may further comprise storing in memory the ion mass for each iteration.

In certain embodiments, providing a set of one or more monosaccharide units comprises providing a plurality of mass spectral data sets obtained from iteratively profiling the oligosaccharide in a mass spectrometer, such that in each iteration a fragment of the oligosaccharide is individually profiled, selecting a plurality of ion masses from the mass spectral data sets, and storing in memory the plurality of ion masses, selecting a fragmentation pathway having a plurality of ion masses from successive iterations, mapping each ion mass on the fragmentation pathway to a set of one or more monosaccharide units. The methods may further comprise selecting a second fragmentation pathway having a plurality of ion masses from a second set of successive iterations. In certain embodiments, selecting a fragmentation pathway includes randomly selecting a fragmentation pathway.

In another aspect, the systems and methods described herein include systems for obtaining information useful for sequencing oligosaccharides. The systems comprise a spectrum screener, and a topology processor capable of receiving the set of one or more monosaccharide units. The spectrum screener includes a peak picking engine for selecting an ion mass from mass spectral data obtained from profiling an oligosaccharide sample in a mass spectrometer, and a composition mapping engine for mapping the ion mass to a set of one or more monosaccharide units, wherein the combined mass of the monosaccharide units when joined to form an oligosaccharide is consistent with the corresponding ion mass of the oligosaccharide. The topology processor includes at least one data structure having at least one data field containing sequence information for one or more monosaccharide units from the set of one or more monosaccharide units. The topology processor may further include an inference database including at least one inference rule, and a constraint algorithm module for applying the at least one inference rule to the set of one or more monosaccharide units and updating the at least one data structure. The at least one data structure may include information useful for sequencing oligosaccharides.

In certain embodiments, the systems further include a control module for operating at least one of the topology processor and the spectrum screener. The systems may include a fragment library including sequence information for one or more fragments of one or more previously characterized samples. In certain embodiments, the sample may include oligosaccharides such as glycans. In certain embodiments, the systems include an AutoSolve algorithm module, cooperating with the constraint algorithm module, for applying a genetic algorithm technique to sequence an oligosaccharide.

In another aspect, the systems and methods described herein include computer systems for use in determining structural information about an oligosaccharide. The computer system may include computer instructions for providing a set of one or more monosaccharide units that make up at least a portion of the oligosaccharide, and populating at least one data structure for the one or more monosaccharide units, wherein the at least one data structure includes at least one data field containing sequence information for the one or more monosaccharide unit. The computer system further includes computer instructions for applying an inference rule to the set of one or more monosaccharide units, and updating the at least one data structure by modifying the sequence information in the at least one data field based, at least in part, on an inference deduced from applying the inference rule. In certain embodiments the computer system further includes computer instructions for determining structural information about the oligosaccharide from the updated data structure.

In another aspect, the systems and methods described herein include a computer-readable medium storing a computer program executable by a plurality of server computers. The computer program may comprise computer instructions for providing a set of one or more monosaccharide units that make up at least a portion of the oligosaccharide, and populating at least one data structure for the one or more monosaccharide units, wherein the at least one data structure includes at least one data field containing sequence information for the one or more monosaccharide unit. The computer program further includes computer instructions for applying an inference rule to the set of one or more monosaccharide units, and updating the at least one data structure by modifying the sequence information in the at least one data field based, at least in part, on an inference deduced from applying the inference rule. In certain embodiments the computer program further includes computer instructions for determining structural information about the oligosaccharide from the updated data structure.

In still another aspect, the systems and methods described herein include methods for resolving the structure of an oligosaccharide. The methods include receiving a plurality of sets of mass spectral data obtained from sequential mass spectrometry of an oligosaccharide, automatically selecting one or more fragmentation pathways from the plurality of sets of mass spectral data, each fragmentation pathway having a set of ion masses corresponding to fragments of the oligosaccharide, identifying one or more monosaccharide units that make up at least a portion of the oligosaccharide from the one or more fragmentation pathways, and resolving a structure of the oligosaccharide by iteratively applying one or more inference rules to the one or more monosaccharide units to refine a structural relationship between the one or more monosaccharide units. In certain embodiments, automatically selecting one or more fragmentation pathways includes selecting one or more fragmentation pathways that do not correspond to an resolved oligosaccharide structure. In other embodiments, automatically selecting one or more fragmentation pathways includes randomly selecting one or more fragmentation pathways.

In another aspect, the systems and methods described herein include methods for detecting the presence of isomers of an oligosaccharide in a sample. The methods may comprise receiving a plurality of sets of mass spectral data obtained from sequential mass spectrometry of the sample, receiving a set of expected oligosaccharides, each having sequence information, selecting a first set of fragmentation pathways from the plurality of sets of mass spectral data, each fragmentation pathway in the first set having ion masses corresponding to fragments of an oligosaccharide in the sample, generating a second set of fragmentation pathways, from the first set, that are consistent with the set of expected oligosaccharides such that fragmentation of each of the set of expected oligosaccharides occurs along at least one of the fragmentation pathways in the second set, and detecting the presence of isomers based on the existence of fragmentation pathways in the first set that are not in the second set.

In yet another aspect, the systems and methods described herein include methods for resolving the structure of an oligosaccharide. The methods may include performing sequential mass spectrometry of an oligosaccharide, including generating a set of mass spectral data for a fragmentation step, automatically selecting an ion mass in the set of mass spectral data, and performing further fragmentations of the selected ion mass. The methods further include generating a fragmentation pathway having ion masses corresponding to ion masses of successive fragments of the oligosaccharide, and resolving a structure of the oligosaccharide by iteratively applying one or more inference rules to the fragments along the fragmentation pathway. In certain embodiments, automatically selecting an ion mass includes selecting an ion mass based at least on its intensity in the mass spectral data and at least one of an associated type of fragmentation and elemental composition of the oligosaccharide.

### BRIEF DESCRIPTION OF THE DRAWINGS

The following figures depict certain illustrative embodiments of the invention in which like reference numerals refer to like elements. These depicted embodiments may not be drawn to scale and are to be understood as illustrative of the invention and not as limiting in any way.

FIG. 1 depicts a system for sequencing carbohydrates, according to an illustrative embodiment of the invention.

FIG. 2 is a flow diagram depicting a process for progressively using sequential mass spectrometry data to sequence carbohydrates, according to one illustrative embodiment of the invention.

FIG. 3 depicts a system for inferring the topology and linkage of a carbohydrate, according to an illustrative embodiment of the invention.

FIG. 4 is a flow diagram depicting a method for inferring the topology and linkage of a carbohydrate, according to an illustrative embodiment of the invention.

FIG. 5 is a block diagram depicting a spectrum screener, according to an illustrative embodiment of the invention.

FIG. 6 is a block diagram depicting the fragment library system of FIG. 1, according to an illustrative embodiment of the invention.

FIG. 7 depicts an example page from the fragment library system, according to an illustrative embodiment of the invention.

FIG. 8 is a chart depicting the MSⁿ disassembly and sequencing of an N-Linked glycan, according to an illustrative embodiment of the invention.

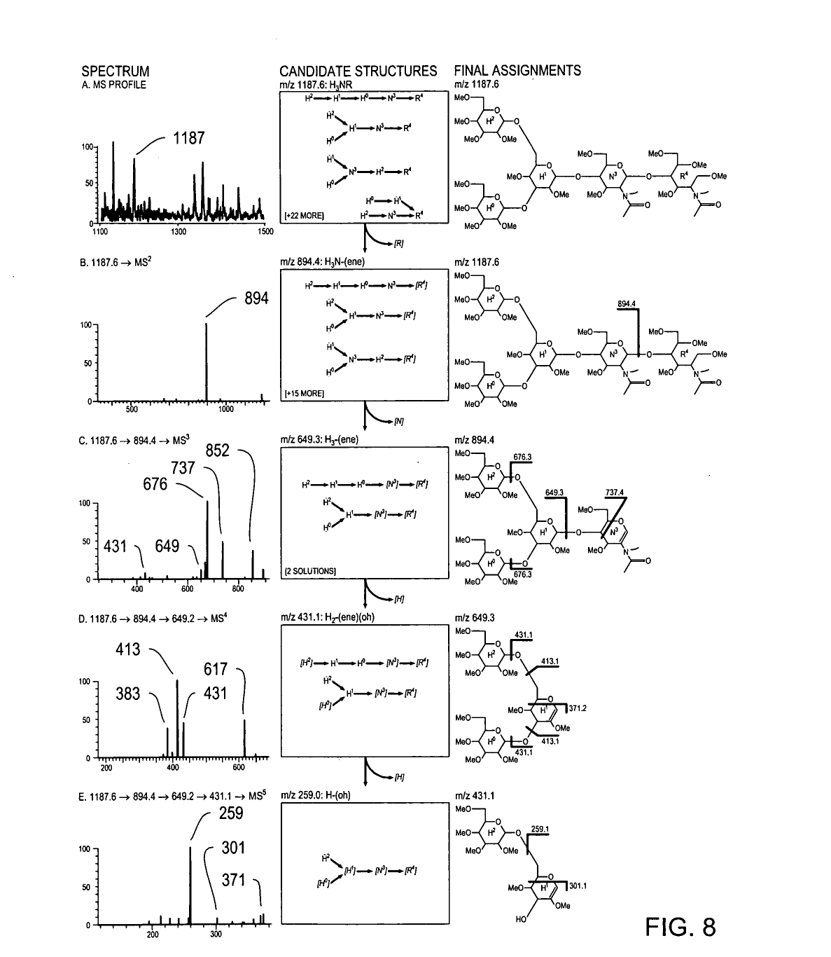

FIG. 9 depicts a system for sequencing carbohydrates, according to an illustrative embodiment of the invention.

### DETAILED DESCRIPTION OF CERTAIN ILLUSTRATED EMBODIMENTS

The systems and methods described herein will now be described with reference to certain illustrative embodiments. However, the invention is not to be limited to these illustrated embodiments which are provided merely for the purpose of describing the systems and methods of the invention and are not to be understood as limiting in any way.

While the following figures are described with reference to oligosaccharides and in some instances specifically with reference to glycans, it is understood that the systems and methods described herein can be used for sequencing any carbohydrate polymer without departing from the scope and spirit of the invention.

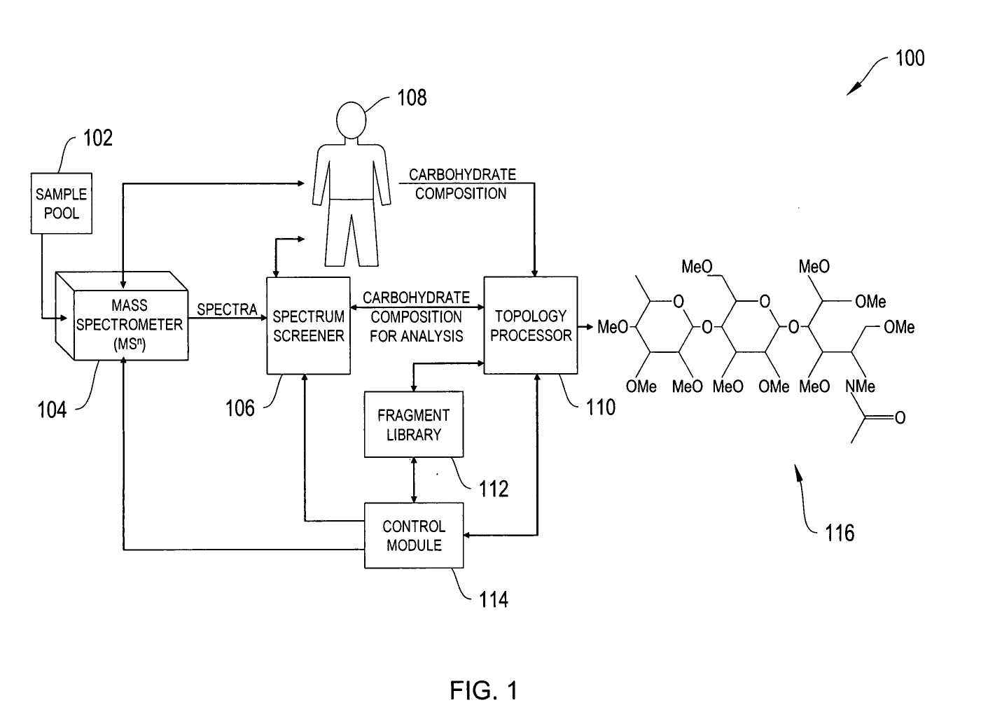

FIG. 1 depicts a system 100 for sequencing carbohydrates according to one illustrative embodiment of the invention. The system 100 includes a mass spectrometer 104, a spectrum screener 106 and a topology processor 110. The system 100 also includes a fragment library 112 and a control module 114. The sample pool 102 includes one or more samples having oligosaccharides. A sample from the sample pool 102 is introduced into the mass spectrometer 104. The mass spectrometer 104 fragments the sample into smaller fragment ions. These sample fragment ions are detected in the mass spectrometer 104 and the corresponding data collected, e.g., as a mass spectrum: a plot showing peaks of relative abundance of the fragments versus their mass-to-charge ratio. The spectrum screener 106 uses the mass-to-charge values of the detected fragment ions to identify compositions of certain carbohydrate polymers. For example, in glycoprotein samples, the desired carbohydrate may be a branching glycan. The composition monosaccharides (“mono”) of the glycan can be identified automatically by the spectrum screener 106 using one or more mass spectra obtained from the mass spectrometer 104. The composition information of the desired carbohydrate is introduced into the topology processor 110. In certain embodiments, a human 108 supplies the topology processor 110 with carbohydrate composition and/or certain mass spectral information.

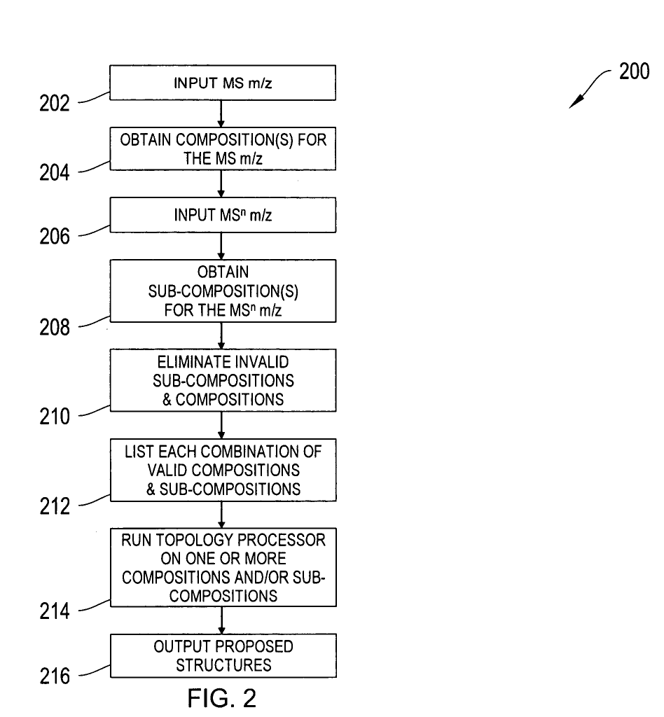

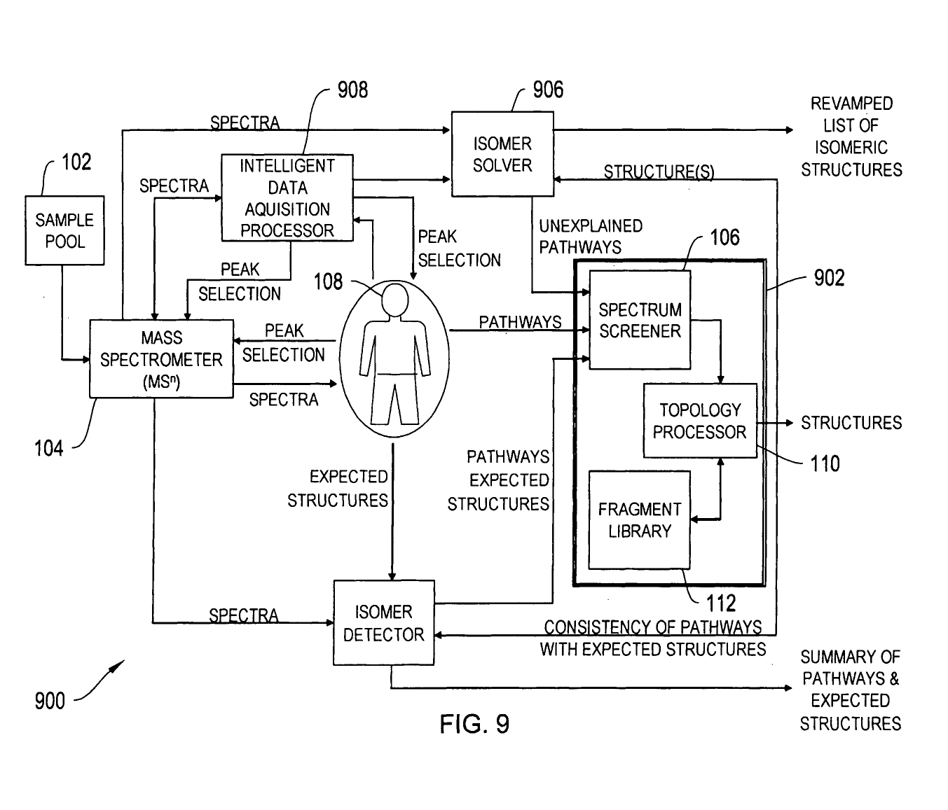

The topology processor 110 outputs a proposed structure 116 of the carbohydrate. The fragment library 112 maintains a searchable database of carbohydrate fragment structures along with their corresponding mass spectral information. The control module 114 is responsible for monitoring and running the various components of the sequencing system 100. In certain embodiments, the topology processor 110, the spectrum screener 106 and a sequential mass spectrometer 104 (MSⁿ) work iteratively (monitored by the control module 114) to progressively fragment a carbohydrate and then deduce its structure by first deducing the structure of each of its fragments. Such a scheme is described in more detail with reference to FIG. 2. As will be described in more detail with reference to FIG. 9, the topology processor 110, spectrum screener 106 and fragment library 112 may be combined with other processing circuitry and interfaces for automatically, semi-automatically or manually resolving carbohydrate structures including structures of isomers.

As used herein, the term “carbohydrate” is any sugar-based structure, including, but not limited to monosaccharides, oligosaccharides, and polysaccharides. In one embodiment, the sample pool 102 includes samples comprising oligosaccharides. The terms “oligosaccharide” and “glycan” as used herein are interchangeable and include several monosaccharides joined together. Typically such oligosaccharides comprise 2 to about 30, 2 to 20, 2 to 12, or even 2 to 10 monosaccharides. The structure of an oligosaccharide may be linear or branched, and branched oligosaccharides may be branched one or more times. Glycan as used herein includes both N-glycans and O-glycans.

The term “N-glycan” as used herein, refers to N-linked glycoprotein glycans, which are attached to the nitrogen atom of protein asparagine residues.

The term “O-glycan” as used herein, refers to O-linked glycoprotein glycans, which are attached to the oxygen atoms of protein serine or threonine residues.

Monosaccharides are generally classified into five groups:

(1) hexoses (“H”) such as glucose, galactose, and mannose of the general structure and numbering system

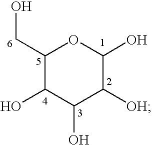

(2) Hexosamines (“N” or “HexNAc”) including N-acetyl glucosamine (GlcNAc) and N-acetyl galactosamine (GalNAc) of the general structure and numbering system

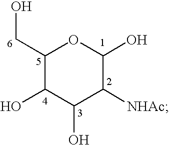

(3) 6-deoxyhexoses (“F”) including fucose of the general structure and numbering system

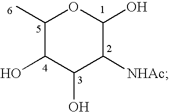

(4) sialic acids (“S”) of the general structure and numbering system

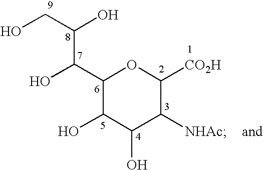

(5) the reducing end monosacchride of the oligosaccharide (“R”), wherein the term reducing end is used to signify the root of the oligosaccharide and is used regardless of whether R has actually been chemically reduced.

In certain embodiments of the invention, the root monosaccharide, R, is reduced prior to analysis by mass spectrometry. In certain such embodiments, this may be accomplished, for example, by treating the oligosaccharide with sodium borohydride dissolved in a sodium hydroxide solution (Ashline, D.; Singh, S.; Hanneman, A.; Reinhold, V. Anal. Chem. 2005, 77, 6250, incorporated herein by reference in its entirety).

In certain embodiments of the invention, the oligosaccharide is derivatized prior to analysis by mass spectrometry. In certain such embodiments, at least one of the hydroxyl groups in the oligosaccharide is methylated, preferably the oligosaccharide is permethylated. Briefly, permethylation may be accomplished by any suitable technique, for example, by dissolving the oligosaccharide sample in dimethylsulfoxide and adding a slurry of sodium hydroxide followed by methyl iodide (Ciucanu, I.; Kerek, F. Carbohydr. Res. 1984, 131, 209).

In certain embodiments, the oligosaccharide is reduced and permethylated prior to analysis by mass spectrometry.

In certain embodiments, the reduced permethylated or unreduced permethylated oligosaccharide is complexed with a metal, e.g., sodium, prior to analysis by mass spectrometry.

The term “permethylated” as used herein means that all of the available OH groups of a structure (monosaccharide or oligosaccharide) are methylated. This may be represented, for example, by the following reaction

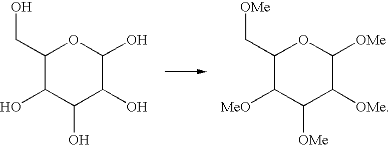

Mass spectrometry (“MS”) is a procedure where a chemical sample is ionized and the mass to charge ratio (m/z) for each fragment ion is measured. The data corresponding to the detected ions can be rendered as a spectrum that indicates the relative abundance of the fragment ions generated from the sample.

Sequential mass specrometry (“MSⁿ”) can isolate a group of ions with a similar m/z (typically a single peak on the spectrum), further fragment those ions, and measure the m/z of the resulting ions. This process can be repeated several times, where a selected group of ions from one cycle of the process can be fragmented to reveal further information about their structure.

Generally, when permethylated glycans are fragmented, the fragments generated have distinct chemical features which affect the fragment ion mass such that the number of cleavages needed to remove the fragment from the original glycan can readily be determined. There are three cleavage types: one that leaves a free hydroxyl (denoted “(oh)”), one that leaves a double bond (denoted “(ene)”), and one that fragments a ring structure (“cross-ring” or “(xring)”). Upon fragmentation, any of these cleavage types may occur, either alone or in combination. For example, shown below is an illustration of three fragments (B) and one possible cross-ring fragment (C) that might arise in the fragmentation of a reduced oligosaccharide FHR.

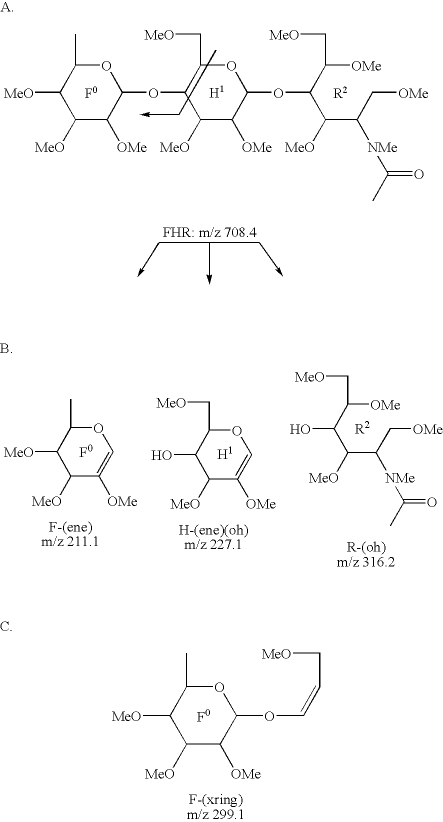

Upon fragmentation, a monosaccharide fragment may exhibit a discernable number of “child scars” and “parent scars” associated with that monosaccharide. As used herein, the term “child scar” is meant to indicate a chemical feature of a fragment ion indicative of fragmentation of a bond between a monosaccharide moiety of the fragment ion and a monosaccharide or oligosaccharide moiety that is distal to the root, i.e., farther from the root of the parent oligosaccharide than the monosaccharide or oligosaccharide of the fragment ion. Similarly, a “parent scar” is meant to indicate a chemical feature of a fragment ion indicative of fragmentation of a bond between a monosaccharide moiety of the fragment ion and a monosaccharide or oligosaccharide moiety proximal to the root, i.e., closer to the root of the oligosaccharide than the subject monosaccharide or oligosaccharide of the fragment ion. For example, if the oligosaccharide H₃NR were fragmented as shown below, then the (H¹)(H²)H³ moiety would have a parent scar from the N-R moiety and the N-R moiety, in turn, would have a child scar from the (H¹)(H²)H³ moiety. Similarly, if the H² moiety were to fragment from the (H¹)(H²)H³ moiety, then the H¹-H³ moiety would have a child scar from the H² moiety and a parent scar from the N-R moiety. The N-R moiety would still have a single child scar, and the H² moiety would have a parent scar from H¹-H³ moiety.

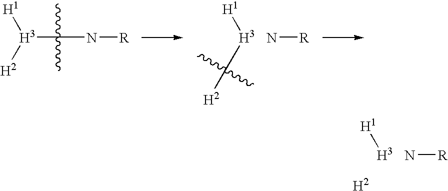

Further, in certain embodiments where a parent scar results from a cleavage of the cross-ring type, information regarding the type of linkage between fragments may be provided upon fragmentation. For example, such cross-ring cleavages may indicate that two monosaccharides were linked via a 1-2 linkage or may indicate that there was a 1-4 or 1-6 linkage.

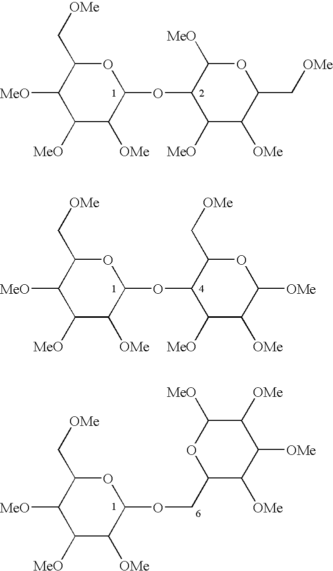

The sample is passed in to the mass spectrometer 104 where it is ionized and fragmented. The mass-to-charge ratio (m/z) of each abundant ion in the mixture is measured. In certain embodiments, the mass spectrometers include ion trap mass spectrometers. The mass spectrometers may include MALDI instruments (Axima-CFR MALDI-TOF, Axima-QIT MALDI-QIT-TOF, Kratos-Shimadzu, Manchester, UK), and a linear ion trap (LTQ, ThermoFinnigan, San Jose, Calif.)

The result obtained from a mass spectrometer is generally a mass spectrum indicating the relative abundance of the ions found. As noted earlier, sequential mass spectrometers, or MSⁿ, can isolate a group of ions with similar m/z (typically those ions that fall into a single peak on the MS spectrum), fragment those ions, and measure the m/z of the generated product ion fragments. The process can be repeated with the product ions from one step being fragmented to reveal further internal detail. The first fragmentation of an MS ion yields an MS² spectrum; the fragmentation of an MS² product ion yields an MS³ spectrum, and so on. In certain embodiments, successive fragmentation of the carbohydrate is tracked by fragmentation pathways. In one embodiment, a fragmentation pathway can be represented as a series of ion m/z values. As an example, a fragmentation pathway may include ion m/z values of 1928.0, 1272.6, 850.5, and 414.9. Typically, each ion in the pathway is generated by fragmenting the previous ion. In the foregoing example, the successive fragmentation starting with a glycan with m/z 1928.0 and passing through product ions with m/z's of 1272,6, 850.5 and 414.9 can be represented as a fragmentation pathway: 1928.0_{—}1272.6_{—}850.5_{—}414.9. As will be described with reference to FIG. 9, an ion having a particular m/z value for further fragmentation may be selected by a user or by an intelligent data acquisition processor configured to communicate with the mass spectrometer.

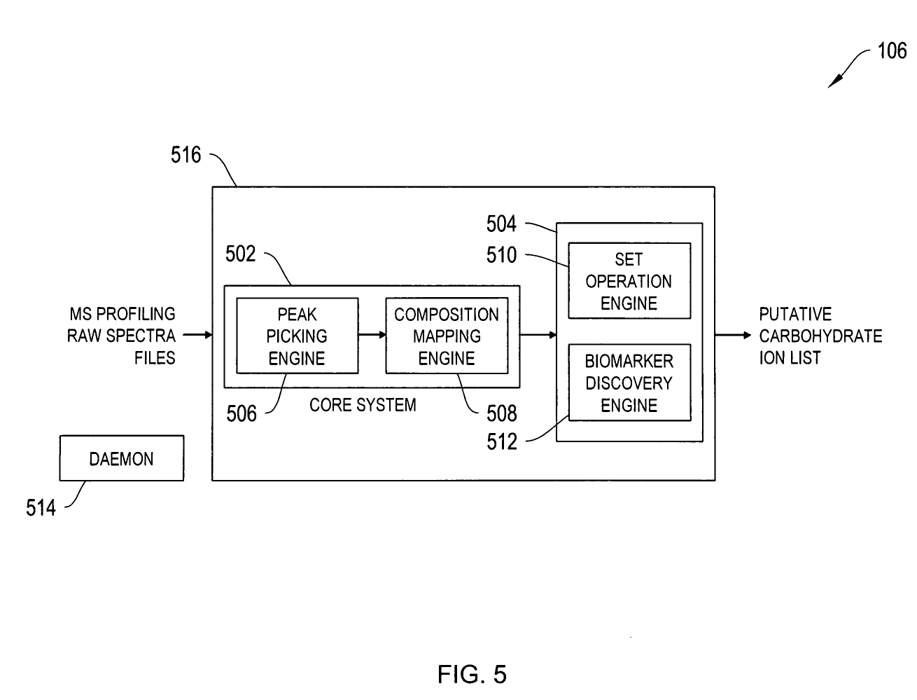

The spectrum screener 106 takes raw mass spectral information as its input and produces a list of one or more carbohydrates with all possible compositions, e.g., oligosaccharides consistent with the mass spectral information, assigned as output. In certain embodiments, the spectrum screener 106 acquires and compares a set of mass spectra (as raw spectra files) as input and produces a carbohydrate ion correlation list with compositions (i.e., sets of monosaccharide components) that have a mass that matches the corresponding ion mass. The terms “mass spectra”, “mass spectrum”, and “mass spectral information” as used herein refer to any data representative of ions generated from the fragmentation of a molecule, such as data obtained by mass spectrometry, whether formatted as a graphical compilation, a table of mass spectral values, or organized, stored, or arranged in any suitable way. The mass spectra files are reduced to certain desired peak lists and the spectrum screener 106 assigns peaks by attempting to fit an ideal isotopic distribution to the experimental data. The spectrum screener 106 converts the ion m/z values into equivalent singly-charged ions and maps mass values to corresponding carbohydrate compositions. The spectrum screener 106 is described in more detail later with reference to FIG. 5.

In certain embodiments, a human operator 108 analyzes the mass spectra obtained from the mass spectrometer 104 and identifies desirable peaks. The human operator 108 then compares the observed m/z value of the peak to a composition database to obtain carbohydrate compositions corresponding to the specified m/z value.

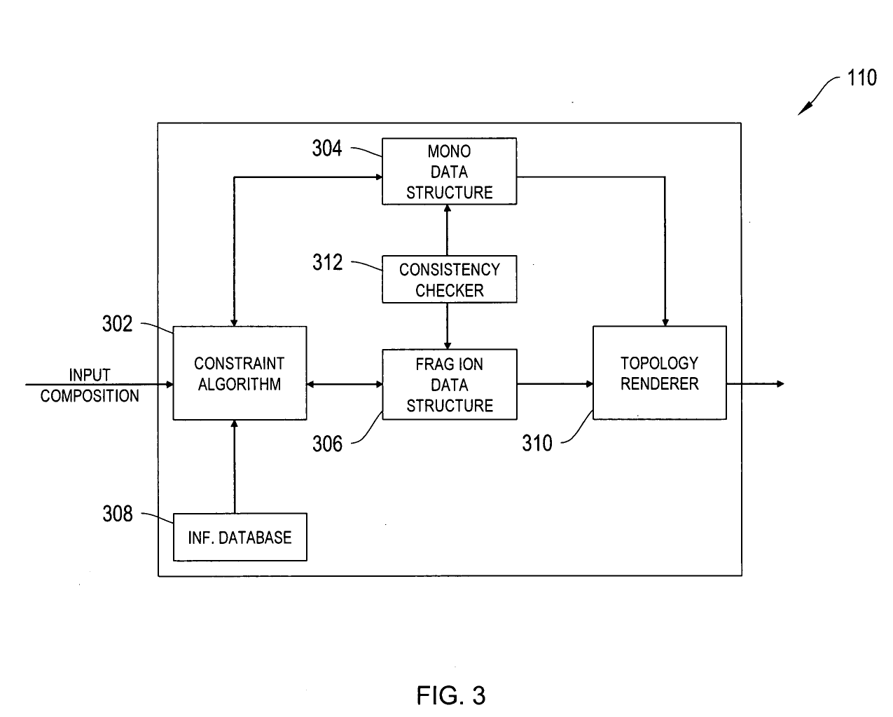

The topology processor 110 accepts as input one or more compositions for one or more carbohydrates and carbohydrate fragments. The topology processor 106 proceeds to deduce a structure for the given composition. In certain embodiments, the topology processor 110 employs few or no restrictions (e.g., based on known structures of natural carbohydrate) on valid carbohydrate structures thereby helping the processor 110 detect novel structures. FIGS. 3, 4 and 5 describe the components and operation of the topology processor 110.

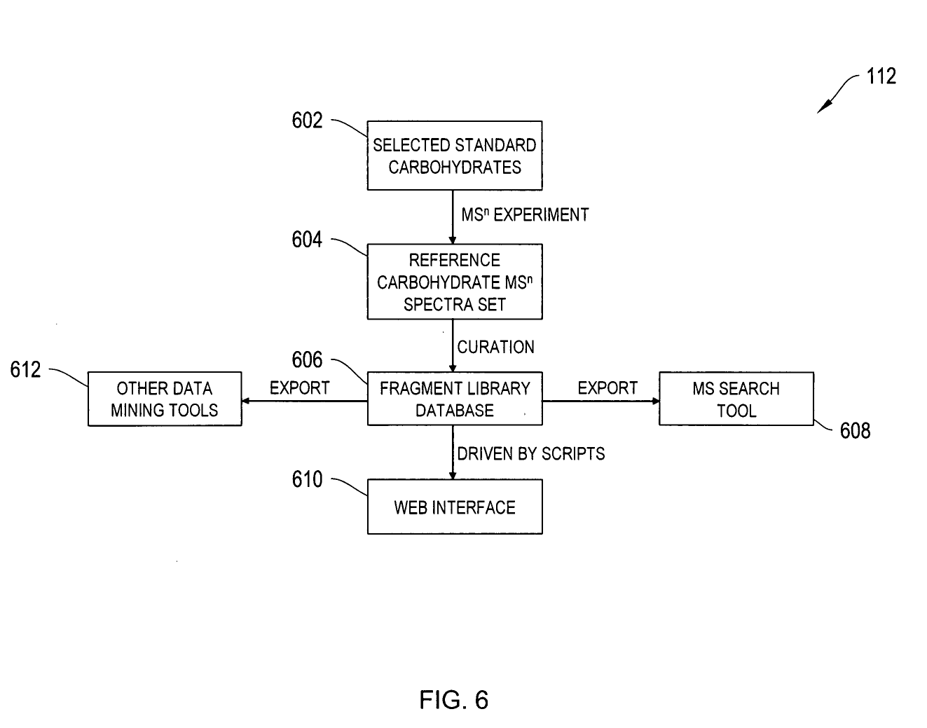

The fragment library 112 is a database having mass spectral data along with corresponding carbohydrate fragment information. The library 112 includes components for library building, spectral searching, comparing and retrieving. Each entry in the library 112 is typically a methylated oligosaccharide or other suitable carbohydrate and its MSⁿ fragmented products. The library 112 is searchable and may be used for confirming a structure obtained from the topology processor 110. The fragment library 112 is described in more detail with reference to FIG. 6.

The controller 114 includes any suitable computer terminal capable of operating at least one of the topology processor 110, the spectrum screener 106, the fragmentation library 112, and the mass spectrometer 104. In certain embodiments, the controller 114 modifies the execution of the mass spectrometer in response to external user input or internal inputs from the topology processor or the spectrum screener.

The controller 114 may include any computer system having a microprocessor, a memory and a microcontroller. The memory typically includes a main memory and a read only memory. The memory may also include mass storage components having, for example, various disk drives, tape drives, etc. The mass storage may include one or more magnetic disk or tape drives or optical disk drives, for storing data and instructions for use by the microprocessor. The memory may also include one or more drives for various portable media, such as a floppy disk, a compact disc read only memory (CD-ROM), or an integrated circuit non-volatile memory adapter (e.g., PC-MCIA adapter) to input and output data and code to and from microprocessor. The memory may also include dynamic random access memory (DRAM) and high-speed cache memory.

FIG. 2 is a flow diagram depicting a process 200 for progressively using sequential mass spectrometry data to sequence carbohydrates, according to one illustrative embodiment of the invention. The process 200 begins with acquiring mass spectral data, such as a mass spectrum MS having peaks at various m/z values, for a sample of interest. An operator 108 or the spectrum screener 106 can choose one or more peaks for further analysis (step 202). The operator 108 and/or spectrum screener 106 and/or a composition database identifies one or more corresponding monosaccharide compositions for the selected peak (step 204) based, at least in part, on the m/z value. The selected m/z peak is fragmented again in the mass spectrometer 104 to produce a mass spectrum MS² showing peaks for one or more fragment ions of the selected peak. One or more desired m/z peaks are selected from the MS² mass spectrum (step 206). This step of obtaining sequential mass spectra may be repeated as many times as desired to obtain a plurality of MSⁿ mass spectra. The operator 108 and/or spectrum screener 106 and/or a composition database identifies one or more possible monosaccharide compositions for the selected fragments or sub-fragments (step 208) based, at least in part, on the corresponding m/z value obtained from the MSⁿ spectra for that fragment's peak. A monosaccharide composition typically includes a set of one or more monosaccharides. The term “monosaccharide composition” refers to a complete set of monosaccharide units present in a carbohydrate structure or a portion thereof, including any duplicate units (i.e., redundant units that occur two or more times within a particular structure) that may be present in the structure. The monosaccharide composition of a structure is the same irrespective of how the individual monosaccharide moieties are joined in the structure. For example, the monosaccharide composition of an ion is the complete set of monosaccharide units present in that ion, such that the mass of the complete set of monosaccharides when joined to form an oligosaccharide, is consistent with the mass of the ion for the oligosaccharide.

As used herein, the term “consistent” is meant to refer to two or more numerical values that agree with one another within a particular numerical tolerance. For example, two masses are consistent if they are within 1 amu, 0.5 amus, or even 0.25 amus of one another.

The controlling module 114 compares the various possible fragment and sub-fragment compositions to the fragment and/or sub-fragment composition obtained from a previous mass spectrum. The fragments and sub-fragments are also compared to the carbohydrate composition. Invalid fragment and sub-fragment compositions are removed from further consideration (step 210). As an example, given MSⁿ m/z, of 1272.6, the mass is first converted to a list of possible compositions. Using a default MSⁿ error tolerance of 0.5 Da, six possible compositions (selected from monos: H₀ H₁ H₂H₃H₄ F₅ F₆ N₇ R₈) are returned by the Composition Finder:

C1) 0-[H4/F1/N1/R0]-1DBL (Including 4 H monos, 1 F mono, 1 N mono and no R monos)

C2) 1-[H4/F1/N0/R1]-(none) (Including 4H monos, 1 F mono, no N monos and 1 R mono)

C3) 0-[H2/F3/N1/R0]-1×6 (Including 2H monos, 3 F monos, 1 N mono and no R monos)

C4) 1-[H2/F3/N1/R0]-1×2 (Including 2H monos, 3 F monos, 1 N mono and no R monos)

C5) 2-[H2/F3/N1/R0]-1×46 (Including 2H monos, 3 F monos, 1 N mono and no R monos)

C6) 2-[H0/F0/N5/R0]-1×2 (Including no H monos, no F monos, 5 N mono and no R monos)

The sequencing system 100 compares the possible product compositions to the composition of the precursor ion, [H5/F2/N1/R1]. Compositions C3, C4 and C5 all have more F Monos (3) than the precursor (2), so they are incompatible product compositions and are discarded. (The product's monosaccharide composition must be a subset of the precursor's monosaccharide composition.) Likewise, composition C6 has more N Monos (5) than the precursor (1), so C6 is also discarded. The two remaining compositions, C1 and C2, are considered viable.

In certain embodiments, a plurality of valid compositions and sub-compositions include monos that might have come from different combinations of ions in the precursor ion. In such embodiments, all or substantially all combinations of valid compositions and sub-compositions (step 212) are considered. As an example, a product ion maps to [H1/F0/N0/R0] and the precursor is [H4/F0/N0/R0], there are four ways the product ion can be subsetted out of the precursor. Since the subsetting is done at the time the product ion is added, the sequencing system 100 may not know which of the four precursor Hs became that particular product H. To solve this problem, the sequencing system 100 merely selects all of the four combinations, and uses each combination to represent one of the four different possibilities.

As the sequencing system 100 collects more information about the carbohydrate, some compositions may be deemed invalid. In this example, the product H is a terminal non-root monosaccharide, or “leaf”, (because the initial zero in “[H1/F0/N0/R0]” signifies that no child scars are present, but in one of the four sub-compositions, that H may also be required to be the parent of some other Mono. This is a logical inconsistency, so the subset will be marked as dead and removed from consideration.

Returning to the running example of the previous section, where we have compositions C1 and C2, we see that those compositions each have multiple ways of being subsetted out of the precursor composition. In both cases, we need to select four H product Monos out of five precursor H Monos, and one F out of two.

The one or more compositions or sub-compositions are introduced into the topology processor 110 (step 214). The topology processor outputs one or more proposed sequenced structures for the carbohydrate being analyzed (step 216).

FIG. 3 depicts a system for obtaining the topology and linkage of a carbohydrate according to an illustrative embodiment of the invention. In particular, FIG. 3 is a block diagram depicting the topology processor 110 of FIG. 1. The topology processor 110 includes a constraint algorithm 302, a monosaccharide data structure 304 (referred to hereinafter as the “mono scorecard 304”) and a fragment data structure 306 (referred to hereinafter as the “fragment scorecard 306”). The topology processor 110 further includes an inference database 308, a consistency checker 312 and a topology renderer 310. A carbohydrate composition obtained from the spectrum screener 106 and mass spectra pathways obtained from the mass spectrometer 104 are introduced to a constraint algorithm in the topology processor 110. The constraint algorithm applies a set of inference rules obtained from the inference database 308 to the composition and uses the output to update the mono scorecard 304 and the fragment scorecard 306. The topology renderer 310 uses the information in the updated mono scorecard 304 and the updated fragment scorecard 306 to build a carbohydrate structure. The topology processor 110 may be implemented in software using a language capable of handling data structures. (Ashline, D.; Singh, S.; Hanneman, A.; Reinhold, V. Anal. Chem. 2005, 77, 6263, incorporated herein by reference in its entirety) and (Ashline, D.; Singh, S.; Hanneman, A.; Reinhold, V. Anal. Chem. 2005, 77, 6271, incorporated herein by reference in its entirety).

The composition of the carbohydrates obtained as inputs into the topology processor 110 may include a set of one or more monosaccharides (simple sugars). In certain embodiments, the carbohydrate being sequenced is abstracted to a tree structure, similar to trees used in computer science data structures. In such embodiments, individual monosaccharides in the carbohydrates are depicted as nodes in a carbohydrate tree. Each node can typically have multiple nodes attached to it. The fragments of the carbohydrates are typically subtrees in the main tree. The trees and subtrees generally each have a single distinguished root node. The other nodes in the tree branch out from the root node. The root node thus has one or more children connected to it. Each node, except for the root node may be connected to one or more parent nodes. The tree may also include leaf nodes, i.e., nodes not connected to any children nodes. In certain embodiments, each node is characterized, at least in part, by the number of parent and children nodes connected to it. Each node or subtree comprising a group of nodes may be characterized by other features, some of which are stored and updated as fields in data structures.

Data structures, similar to data structures in computer science, help store information learned about the carbohydrate being processed, and acts as a kind of scorecard to track progress. The mono scorecard 304 contains a data structure for each monosaccharide in the carbohydrate composition.

The mono scorecard 304 collects information about the monosaccharides (“monos”) that are linked together to form a carbohydrate. If the carbohydrate is a glycan and contains five monosaccharides, then topology processor 110 can contain five mono scorecards 304. In one embodiment, each mono scorecard 304 contains a plurality of fields representative of topological or linkage properties of the corresponding monosaccharide. In certain embodiments, the mono scorecard 304 includes the following fields:

1. ParentPossible: The set of possible parents of this mono.

2. ParentDefinite: The set of definite parents of this mono.

3. ChildrenPossible: The set of possible children of this mono.

4. ChildrenDefinite: The set of definite children of this mono.

5. NumChildrenPossible: The number of possible children this mono has.

6. LinkageMonoToParentPossible: Contains the possible linkage positions of this mono's Parent that this mono can connect to.

7. LinkageMonoToChildrenPossible: Contains the possible linkage positions at which this mono may have children.

8. LinkageMonoToChildrenDefinite: Contains the definite linkage positions at which this Mono must have children.

The mono scorecard 304 may include other fields representative of topology or linkage for one or more monosaccharides without departing from the scope of the invention.

The fragment scorecard 306 includes information about a carbohydrate substructure revealed by fragmentation. The substructure is a fragment typically represented as a subtree in a tree-type data structure. Each revealed subtree (fragment ion) is represented by a fragment scorecard 306. In one embodiment, each fragment scorecard 306 contains a plurality of fields representative of topological or linkage properties of the corresponding carbohydrate fragment. In certain embodiments, the fragment scorecard 306 includes the following fields:

1. Composition: The inferred composition (monosaccharide residues plus cleavage scars) of the ion fragment.

2. ChildScars: The number of scars (0 to 4) left by any child monos which have been cleaved off.

3. ParentScars: The number of scars (0 or 1) left by a parent mono having been cleaved off.

4. RootPossible: The set of possible roots of this fragment.

5. RootDefinite: The set of definite roots of this fragment. (The substructure contained by this fragment must have exactly one root mono.)

6. RootParentPossible: The set of monos that might be the parent of this fragment's root mono.

7. RootParentDefinite: The set of monos that are definitely the parent of this fragment's root. The set must contain zero or one monos: zero for any fragment whose root is the carbohydrate's root, otherwise one.

8. LinkageRootToRootParentPossible: The set of possible positions of this fragment's RootParent to which the fragment's Root could connect.

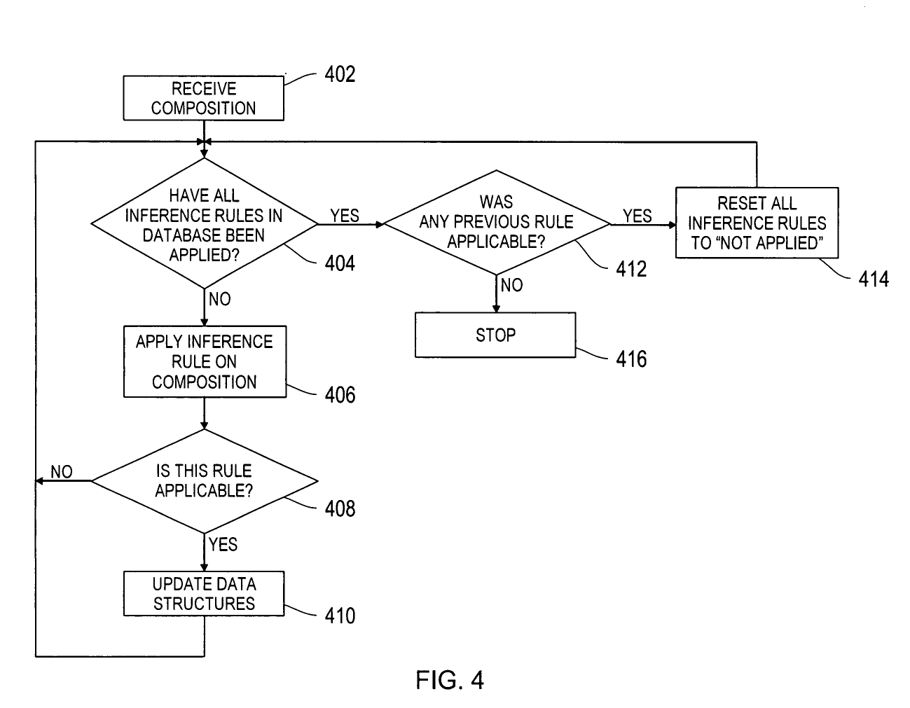

The constraint algorithm 302 obtains a carbohydrate composition (a complete carbohydrate or a fragment) to be sequenced and populates the fields in the mono scorecard 304 and the fragment scorecard 306. The various fields are initialized as described earlier. The constraint algorithm 302 progressively clears or fills the information contained in these fields until a termination condition is reached. In certain embodiments, a termination condition is reached when the information contained in certain fields have been narrowed down or exhausted. In other embodiments, the termination condition includes at least one of a time limit and a desired structure being obtained. The constraint algorithm may take a single mono scorecard 304 or a single fragment scorecard 306 and attempt to update them or multiple scorecards in a way that progresses toward a solution sequence. In particular, the constraint algorithm 302 chooses to fill, clear and/or edit information in the fields based, at least in part, on a set of inference rules contained within the inference database 308. The inference rules are a set of rules that infer, from the information contained in the scorecards 304 and 306 and optionally additional information contained elsewhere, connections between each mono in the tree using logical constraints of trees and subtrees. The constraint algorithm 302, using the inference rules, progressively eliminates structures that might be deemed logically and/or chemically/biologically inconsistent. This is described more fully in FIG. 4.

The inference database 308 includes a plurality of inference rules, each capable of being applied independently to the composition (fragment) being sequenced. In certain embodiments, the inference database 308 includes at least 30, at least 40, or even about 50 inference rules. The inference database 308 may contain more or fewer inference rules without departing from the scope of the invention. In certain embodiments, the inference rules help infer branching (parent/child relationship) and linkage positions. The constraint algorithm 302 in connection with the inference database 308 and mono and fragment scorecards 304 and 306 may be implemented in a software program using a language such as C++. In certain embodiments, one set of inference rules are applied to the mono scorecards 304 and another set of inference rules are applied to the fragment scorecards 306. An example set of 11 inference rules and the nature of inferences obtained from them are described below. The names for these inference rules are the same as the C++ functions that implement the particular inference rules.

1. InferNumChildrenForSingleton (Uses the Fragment Scorecard 306)

If the fragment contains a single mono and the fragment scorecard 306 indicates N child scars, then we know that all of those N child scars belong to the mono. We, therefore, know that the mono must have had exactly N children. We update the mono scorecard 304 by restricting the field “NumChildrenPossible” to contain only the value N.

2. RootPlusOnlyLeaves (Uses the Fragment Scorecard 306)

If a fragment contains N monos and N−1 of the monos are known to be leaves (that is, to have no children), then the Nth mono must be the parent of the N−1 monos. We update the mono scorecard 304 by restricting the “ParentPossible” field for each of the N−1 monos to contain only the Nth mono. Furthermore, since all of the monos in the box must be a connected substructure, the monos must be linked together. However, since N−1 of the monos cannot have children, only the remaining Nth mono can have children. Further, that Nth mono must have as children all of the other monos that share its fragment.

3. ApplvBoxLinkage (Uses the Fragment Scorecard 306)

In certain embodiments, the ion composition of the fragment represents a cross-ring fragment that includes only the 6 position of the fragment's parent mono. In such embodiments, the fragment must be linked to position 6 of its parent mono. On the fragment scorecard 306, the field “LinkageRootToRootParentPossible” is set to {6}. The only monos that could be the root of the substructure in fragment are those that might be 6-linked to their parent. Therefore, we can use this linkage information to remove from “RootPossible” field in the fragment scorecard 306 any mono which does not have 6 in its “LinkageMonoToParentPossible” field of the mono scorecard 304.

4. RestrictParentPossibleGivenCrossRingBox (Uses the Fragment Scorecard 306)

In certain embodiments, the cross-ring fragments also contain a -(oh) scar at a specific position. For example, the cross-ring fragment may contain a -(oh) scar at its 6 position in addition to a child scar at position 4. Therefore, that mono was connected to a residue that had a child at both its 4 and 6 positions. We can therefore eliminate from the mono scorecard 304 any mono which (1) does not have 2 or more children (“NumChildrenPossible”) or (2) does not have both position 4 and 6 available to attach children (“LinkageMonoToChildrenPossible”).

5. ApplyLeaf (Uses the Mono Scorecard 304)

If we know that the mono is a leaf from the mono scorecard 304 field “NumChildrenPossible={0}”, then the inference rule updates the scorecards in at least the following ways: (1) Clear the “ChildrenPossible” field in the mono scorecard 304 to empty (because the mono has no children), (2) Remove the mono from the “ParentPossible” field for all other monos (because this mono is a leaf and cannot be the parent of any mono), (3) Remove the mono from the “RootParentPossible” field for all fragment scorecards 306 (because no fragment can attach to this mono), and (4) Remove the mono from the “RootPossible” field for all mono scorecards 304 which contain more than one mono (since some other mono in those fragments must be the roots).

6. NoPossibleParentslmpliesMSRoot (Uses the Mono Scorecard 304)

If the mono has no possible parents (the “ParentPossible” field in the mono scorecard 304 is empty), then the mono must be the root of the entire carbohydrate.

7. ApplyMSRootToAnnBox (Uses the Fragment Scorecard 306)

If fragment contains a mono, where the mono is known to be the root of the carbohydrate then the mono must also be the root of the fragment. Update the fragment scoreboard 306 by restricting “RootPossible” field in the fragment scorecard 306 to the mono.

8. ApplyMSRootToAnnMono (Uses the Mono Scorecard 304)

If the mono is known to be the root of the entire carbohydrate, this inference rule updates the mono scorecard 304 by (1) clearing the “ParentPossible” field (because the root cannot have a parent) and (2) removing the mono from the “ChildrenPossible” field from all mono scorecards 304 (because the root cannot be a child).

9. AllChildreriAccountedFor (Uses the Mono Scorecard 304)

Suppose that a particular mono scorecard 304 knows that it has exactly N children (“NumChildrenPossible” field is set to {N}) and that those children are all known (“ChildrenDefinite” field contains those N monos). We therefore know that all children of the mono have been found, and update the scoreboard by removing the mono from the “ParentPossible” field from all monos other than its definite children.

10. AssignChildLinkage (Uses the Mono Scorecard 304)

If the mono has a definite child C (the “ChildrenDefinite” field in the corresponding mono scorecard 304 contains the child C) and the child C has a definite linkage L to its parent mono (“LinkageMonoToChildrenPossible” field in the child's mono scorecard 304 contains the single value L), then we know that linkage L on parent mono is “taken” by child C. The inference rule updates all other definite children of the mono and removes L from their “LinkageMonoToParentPossible” field.

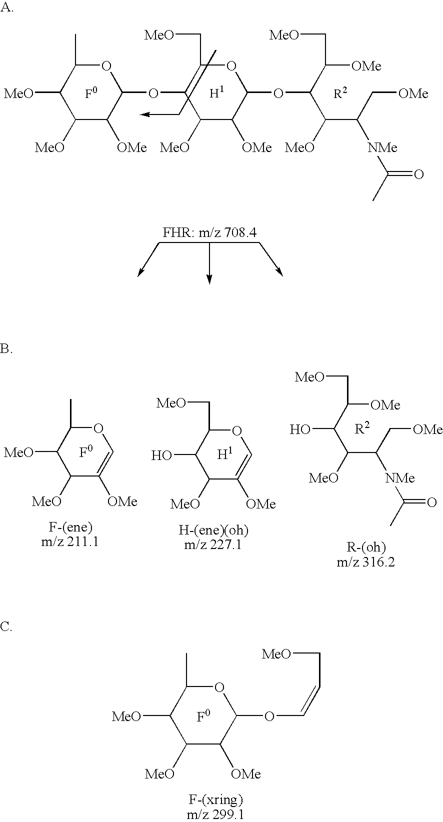

11. InferNumChildrenFromCrossRingCleavage (Uses the Fragment Scorecard 306)

Referring to the illustration on the right, in one embodiment, the algorithm has so far deduced that the cross-ring fragment in (C) must have come from the mono H¹. Because the cross-ring fragment has a methyl group at position 6, we can infer that H¹ cannot have had 4 children. (If it had, they would have been at positions 2, 3, 4, and 6.) The inference rule updates the H¹ mono scoreboard by removing 4 from “NumChildrenPossible” field.

In certain embodiments, logical inconsistencies in the mono scorecard 304 and the fragment scorecard 306 are revealed by the consistency checker 312. Typically, logical inconsistencies indicate that the given composition may not produce a valid carbohydrate structure, and so they can be removed from further consideration. In certain embodiments, a composition includes a combination of scorecards 304 and/or 306.

In certain embodiments, a composition is considered inconsistent if any of the following conditions are met:

1. A fragment has no possible root mono.

2. Any mono scorecard 304 has:

a. NumChildrenPossible={ } (because even if it had no children the set should be {0} instead of empty)

b. ParentPossible={ } (and is not possibly the root of the glycan)

c. LinkageMonoToParentPossible={ } (and is not the root of the glycan)

d. LinkageMonoToChildrenPossible fails to contain any member of the set LinkageMonoToChildrenDefinite

e. More ChildrenDefinite than ChildrenPossible

3. Any fragment scorecard 306 has:

a. RootPossible={ } (because every fragment must have a root)

b. Exactly two monos M1 and M2 but (1) M1 does not link to M2 and (2) M1 does not link to M1

c. More ChildScars than the sum of the maximum number of children of all contained fragment scorecard 306.

The topology renderer 310 collects the information contained in the mono scorecard 304 and the fragment scorecard 306 and then outputs a representation of the of carbohydrate structure. The topology renderer 310 may be integrated with commercially available chemical drawing software such that topology and linkage information from the scorecards 304 and 306 may be used to construct an image of the structure. The topology renderer 310 may include other rendering engines without departing from the scope of the invention. The topology renderer 310 may be configured to include features such as anti-aliasing and high-speed zooming and navigating display contents.

FIG. 4 is a flow diagram depicting a process 214 for inferring the topology and linkage of a carbohydrate according to an illustrative embodiment of the invention. In particular the process 214 corresponds to a step in process 200 shown in FIG. 2. The process 214 begins when the topology processor 110 receives one or more compositions and/or sub-compositions from the spectrum screener 106 and/or a human operator 108 and/or a composition database (step 402). The topology processor 110 may receive compositions or sub-compositions from any other source without departing from the scope of the invention. The constraint algorithm 302 checks the inference database 308 to see if all the inference rules contained in the database 308 have been applied to the composition (step 404). If at least one of the inference rules in the database 308 has not been applied to the composition, the constraint algorithm 302 applies an inference rule to the composition (step 406). In certain embodiments, the inference rule may be selected randomly from among a plurality of inference rules in the inference database 308. In other embodiments, the inference rule may be selected specifically as desired from among a plurality of inference rules in the inference database 308. The applied first inference rule may or may not produce certain inferences about the composition. In certain embodiments, the process 214 checks to see if the rule produced certain inferences about a composition (step 408). If applying the inference rule produced certain inferences about the composition, the mono scorecard 304 and the fragment scorecard 306 are updated to reflect this recently acquired inference (step 410). If applying the inference rule produced no inferences and did not result in an update in either one of the mono scorecard 304 or the fragment scorecard 306, the process is repeated for a different inference rule.

12. Intensity-based Inference Rules

Glycosidic bonds that originate from HexNAc and sialic acid residues (N and S in the software's nomenclature) are often weaker than the bonds from other residue types such as H and F residues. The software can therefore recognize that high-abundance MSn fragments are often created by the rupture of these N and S bonds; these weak bonds break more readily than the stronger bonds, leading to recognizable fragmentation patterns.

Consequently, the software can make structural inferences from the observed high-abundance MSn fragments which may provide additional constraints upon the glycan structures proposed by the software, reducing the number of structures proposed, and also improving the quality of the proposed structures.

In certain embodiments, after all the inference rules in the database 308 have been applied, the constraint algorithm 302 checks to see if any previously applied rule was deemed applicable (step 412). If so, all the inference rules in the database are converted from an “applied” to a “not applied” status (step 414) and the process 214 is repeated after step 402. If none of the previously applied rules were deemed applicable, the process 214 is stopped (step 416). Alternatively, each time an inference rule is deemed applicable, all inference rules may be converted from an “applied” to a “not applied” status and the process 214 repeated after step 402.

In certain alternative embodiments, the constraint algorithm 302 includes a command flag (“UnmethylatedReducingEnd”) to allow the user to process a wider collection of carbohydrates, in particular, ones that have a -(oh) or -(ene) scar at the reducing end. This type of carbohydrate is common in the analysis of glycolipids, where the glycan is fragmented from the lipid within the mass spectrometer. The resulting glycan is not methylated at the reducing end carbon, but instead has a -(oh) cleavage scar. In certain embodiments, the use of this flag allows the constraint algorithm 302 applying the inference rules to reason about carbohydrates of this type. For example, when this flag is given, the inference rules instead assume that the root mono must contain a parent scar.

In an alternative embodiment, the constraint algorithm 302 is capable of supporting the appearance of cross-ring cleavages. Each monosaccharide class (H, F, N, R, S) can have its ring cleaved in various ways to support a range of recognized fragments. Cross-ring fragments may themselves contain scars. The constraint algorithm 302 can use this information in assigning a structure.

For example, consider the cross-ring fragment shown in the adjoining figure. As drawn, we know that residue F⁰ was 1-4 linked to residue H¹. However, the constraint algorithm 302 would be unable to determine whether F⁰ was 1-4 or 1-6 linked to H¹, because the mass of the fragment would be identical for both linkage possibilities. Because the cross-ring fragment in the figure contains a methylated position, the constraint algorithm 302 can infer that residue H1 had one child at either position 4 or 6, but could not have had children at both 4 and 6. If the cross-ring fragment had contained a -(oh) cleavage scar, then constraint algorithm 302 could deduce that both positions 4 and 6 had been linked to child residues.

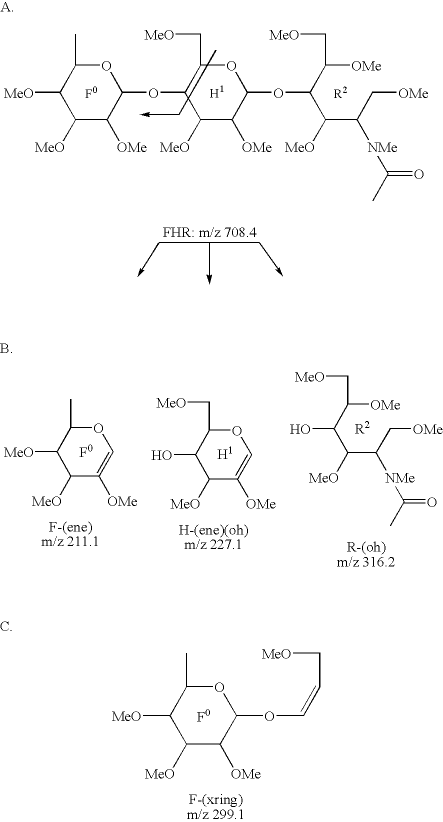

The user may give the sequencing system 100 a fragmentation pathway, e.g., with a command similar to the one shown below:

AddPathway 1928.0_{—}1272.6_{—}850.5_{—}414.9

Typically, the algorithm 302 will try to assign both glycosidic (non-cross-ring) fragments and cross-ring fragments to every ion in the pathway, yielding a large number of possibilities.

In certain embodiments, the use has the option of adding a NoCrossRing option:

AddPathway NoCrossRing 1928.0_{—}1272.6_{—}850.5_{—}414.9

In such embodiments, only glycosidic fragments are considered for each mass number, helping to increase the algorithm's 302 processing speed. This is an example of the constraint algorithm 302 accepting meta-information from the human analyst.

In other embodiments, constraint algorithm 302 has the capability of allowing for multiply-charged ions. For example, 1141.6×2_{—}1797.0 represents a fragmentation pathway with two ions, the first doubly-charged and the second singly-charged. A human analyst is often able to infer the charge state of a given ion by examining the spacing of the peaks in the ion's isotopic envelope. (If the isotopic peaks occur at intervals of 1 m/z, the charge is +1; if at intervals of ½ m/z, +2; if at intervals of ⅓ m/z, +3; and so on.) The input notation allows the analyst to easily provide the algorithm with this important information. In certain embodiments, the sequencing system 100 may automatically recognize multiply-charged ions from the isotope pattern surrounding a peak, thereby eliminating the need for human intervention.

In another embodiment, the topology processor 110 provides a command (“LabelPathway”) for accepting a fragmentation pathway (and an optional NoCrossRing option) and displays the possible compositions for each ion in the pathway. This command provides a convenient way for the analyst to discover possible compositions for each ion in a fragmentation pathway.

Given the input:
LabelPathway NoCrossRing 1678.0_{—}1384.6_{—}1125.5_{—}866.4_{—}662.3_{—}417.3

the command produces this report:
Ion 0 has 1 possible composition:
MS: 1677.87H3/N3/r1
Ion 1 has 1 possible composition:
MSn: 1384.68 (0:0oh+0ene)->H3/N3->ene
Ion 2 has 1 possible composition:
MSn: 1125.54 (1:0oh+lene)->H3/N2->oh
Ion 3 has 1 possible composition:
MSn: 866.40 (2:2oh+0ene)->H3/N1->ene
Ion 4 has 1 possible composition:
MSn: 662.30 (2:1oh+lene)->H2/N1->oh
Ion 5 has 1 possible composition:
MSn: 417.17 (2:1oh+lene)->H2->oh

However, the similar command
LabelPathway NoCrossRing 1678.0_{—}417.3 produces the output:
Ion 0 has 1 possible composition:
MS: 1677.87H3/N3/r1
Ion 1 has 2 possible compositions:
MSn: 417.16 (4:0oh+4ene)->N2->oh
MSn: 417.17 (2:1oh+lene)->H2->oh

In such embodiments, the results are not just a dump of all matching entries in a database. Instead, the product ion is generally derivable from its precursor ion via logical rules. In the second output listing, we see that the ion m/z 417.3 maps to two different compositions (N2 plus scars, and H2 plus scars). However, in the first listing, the same ion m/z 417.3 produces only the H2 composition; the N2 composition has been ruled out because the precursor ion m/z 662.3 has a composition of H2N plus scars. Clearly, the N2 composition for 417.3 could not have come from fragmenting H2N.

Such an intelligent composition filtering is achieved as follows:

1. For each ion in the pathway, retrieve all compositions in the database that are sufficiently close to (i.e., within a predetermined range of) the ion's m/z value (e.g, 0.5 m/z, or even less).

2. For each ion I in the fragmentation pathway (other than the first ion):

a. If no composition associated with I's precursor ion could be fragmented to produce I's associated composition C, then remove C from I's composition list.

3. For each ion I in the fragmentation pathway (other than the last ion):

a. If I's composition C could not be fragmented to produce any of the ions associated with fragmenting I's product ion, then remove C from I's composition list.

4. Repeat from step 2 until no compositions are removed from any ion's list. Note that step 2 filters based on precursor ions while step 3 filters on product ions.

When this algorithm completes, the resulting composition lists typically exclude any logically impossible composition fragmentations anywhere along the entire pathway.

Additionally and optionally, certain features and components may be included in the sequencing system 100 for providing additional functionality as described below.

AutoSolve

In certain aspects, the topology processor 110 includes certain components in addition to those depicted in FIG. 3. In one embodiment, the topology processor 110 is configured to run an Autosolve process for applying genetic algorithm techniques to sequencing carbohydrates and inferring carbohydrate structures. The AutoSolve process is built upon the constraint algorithm 302 functionality. The topology processor 110 typically takes multiple sets of fragmentation pathways, decides which sets are promising for making an assignment, and then “mates” these sets to produce offspring sets that move progressively closer to a definite structure assignment.

In one embodiment, the process proceeds as follows:

1. Given a set of raw spectral files and a mass for the intact carbohydrate, the AutoSolve process extracts all structurally informative fragmentation pathways from the data files. (A pathway is considered to be structurally informative if the sequencing system 100 can assign a plausible composition to most, if not all, ions in the pathway.) These pathways are stored together in a pathway set.

2. A population of random individuals is created. Each individual is assigned a small number of fragmentation pathways selected randomly from the pathway set.

3. If any individual contains less than a user-selectable (or other predetermined) number of pathways, add random pathways until the threshold is met.

4. Screen the population for any duplicate individuals (that is, individuals that have exactly the same set of pathways). If duplicates individuals are found, select one of them and add another random pathway from the set. This step improves the diversity of the gene pool.

5. Evaluate the fitness of every individual. To calculate an individual's fitness, all of its contained fragmentation pathways are added to the data structures in the topology processor 110, and the normal constraint algorithm 302 processing is performed. The number of distinct carbohydrate structures produced is the fitness for that individual, so a smaller fitness represents a better combination of pathways. (That is, a fitness of 1 is optimal, meaning that the given combination of pathways yields a single, distinct structure.) If the constraint algorithm 302 analysis produces no valid carbohydrate structures, an arbitrary large fitness score is assigned to the individual.

6. The individuals are sorted according to their fitness.

7. If the best individual meets the user's completion criteria (or any predetermined completion criteria), or if the AutoSolve process has surpassed the user-supplied generation limit (or any predetermined generation limit), report the pathways contained by the fittest individuals and the structures with which those pathways are compatible.

8. Otherwise, the AutoSolve process creates a new generation of individuals by mating and mutating members of the current generation. Specifically (where N, M, K, and R are user-selectable constants):
a. Copy the N fittest individuals unchanged to the next generation. This guarantees that generations cannot regress by losing their fittest individuals.
b. Two individuals are rank selected (where fitter individuals are more likely to be selected than less fit individuals) and mated. Two offspring are created, with elements of each parent pathway randomly copied to one of the two offspring. Repeat (b) to produce M offspring.
c. Rank select K individuals and mutate them. The mutation operators may include one or more of the following: (1) add one or more random ion masses from the set of ion masses in the raw spectral data, (2) remove one or more ion masses from the pathway, (3) replace a sequence of one or more ion masses with a random sequence of one or more ion masses selected from the set of ion masses in the raw spectral data.
d. Add R random individuals to the next generation. This guarantees that new genetic information is available at each generation.

9. Goto to step 3.

At the end of this process (when step 7 signals termination or after a predetermined time limit or processing limit has passed), the user may be presented with the set of fittest individuals. The user can accept the results with or without interpretation, or can use these individuals to narrow the search for carbohydrate structures. In either case, the AutoSolve process has helped by sifting through a mass of structurally informative pathways and presented novel combinations that evaluate to a small number of possible carbohydrate structures. Alternatively, the output of the AutoSolve process can automatically be used as a starting point for further analysis according to any other suitable process discussed herein. In other embodiments, that are described with reference to FIG. 9, the sequencing system 100 include processors for searching a pathway combination space and generating candidate structures in a more automated manner.

In certain embodiments, an AutoSolve process may produce a set of isomeric topologies that together explain most or all of the observed disassembly pathways by producing one or more topologies per round of search and performing additional rounds until all pathways have been explained.

In one such embodiment, the process comprises:

1. Extracting pathways from spectrum files.

2. Selecting a set of pathways that are, together, not consistent with any structure proposed so far. These become the seed for this round of the search.

3. Continuing to add pathways to the seed until the topology processor returns a single structure (or a very few structures) for the set of pathways.

4. Adding the generated structure(s) to the set of identified structures.

5. Optionally return to step 2 until all input pathways have been used to propose structures.

6. Report set of identified structures.

Rank Scoring

The isomers produced by an AutoSolve process may be scored and ranked to provide additional information about how well each structure fits with the accumulated data. In one embodiment, an AutoSolve process may score each structure by dividing the number of pathways consistent with the structure by the total number of pathways that terminate on consistent spectra.

Returning to FIG. 1, the spectrum screener 106 takes raw mass spectra as its input and produces a list of one or more carbohydrates with all possible compositions assigned as output. The spectrum screener 106 is described in more detail below with reference to FIG. 5.

FIG. 5 is a block diagram depicting a spectrum screener 106 according to an illustrative embodiment of the invention. The spectrum screener 106 includes a core module 502, an extension module 504, a daemon module 514 and a graphical user interface (GUI) 516. The core module 502 includes a peak picking engine 506 and a composition mapping engine 508. The extension module 504 includes a set operation engine 510 and a biomarker discovery engine 512. The spectrum screener 106 may support both N-glycans and O-glycans. In certain embodiments, the system utilizes information provided by the user to narrow the range of possibilities for the parent carbohydrate structure. For example, N-glycans typically contain a core tree having five monosaccharides connected as shown below.

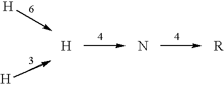

Thus, if the system is informed that the sample is an N-glycan, it may assume that the carbohydrate structure includes as its root the five monosaccharides in this configuration, and may restrict its computational efforts to determine how other monosaccharides are added to this root to form more complicated N-linked glycans. The spectrum screener 106 may support a variety of monosaccharide types, such as Hex, HexNAc, Fuc, NeuAc, NeuGc, phosphate and sulfate. The spectrum screener 106 also supports reduced and non-reduced glycans, native and methylated samples, different adducts (Na+, K+, H+), and positive/negative ions. In addition, the spectrum screener may also support reduced hexose (denoted h) and reduced deoxyhexose (f) residues which may help the software to identify N-linked glycans that do not contain the usual five-residue N-linked core. FIG. 47 of the Lapadula PhD Thesis shows an example of such structure. Additionally, spectrum screener 106 is capable of supporting both absolute (Dalton) and relative (ppm) error tolerances.

In operation, the spectrum screener 106 core module 502 accepts raw mass spectral files and outputs a candidate ion list with possible compositions assigned. The core module 502 is configured to accept many commonly used native mass spectral formats. The peak picking engine (PPE) 506′ reduces raw profiling mass spectra data to high quality peak lists. In one embodiment, the PPE 506 includes the Mascot Distiller COM library from Matrix Science Ltd. The PPE 506 detects peaks by attempting to fit an ideal isotopic distribution to the experimental data. The charge states of ion peaks are also determined during this step and can be converted to equivalent singly charged ions for easier processing. In another embodiment, the PPE 506 identifies local maximums of signal points from the raw mass spectral files that have a higher intensity than a certain number of neighboring signal points. The PPE 506 then determines, for each of one or more charge states, whether the intensity of one or more of the local maximums fall above a certain predetermined threshold value. The PPE 506 then selects the local maximums that lie above the threshold value (and, optionally, have suitable associated isotopic envelopes) as peaks for further processing by the composition mapping engine 508.

The composition mapping engine (CME) 508 accepts the peak list passed by PPE 506 and maps the m/z values to corresponding possible compositions. The CME 508 includes a pre-calculated composition/mass list hosted in a relational database, such as a MySQL database. In certain embodiments, the database includes a set of simple ions (such as mono-, di-, and oligosaccharides) and a set of modifier ions (such as H+, Na+, etc.) that may bind a simple ion to form a complex ion detectable by the mass spectrometer. In such embodiments, the CME 508 may generate a set of permissible complex ions as combinations of simple ions and modifier ions (e.g., considering that simple ions including carboxylate functionalities may lose an H+ ion when bound to two Na+ ions, etc.) and map detected m/z values to the m/z values associated with the combined set of simple and complex ions.

In certain embodiments, the mass spectral data may correlate with one or more different ion compositions for a particular carbohydrate composition. In such embodiments, the CME 508 is configured to generate all such ion forms of the carbohydrate composition and determine neutral ion mass of a particular mass spectral peak or local maximum. Based on the neutral ion mass of a peak, the CME 508 may be configured to determine carbohydrate compositions for the neutral ion mass peaks. In certain embodiments, for each of the compositions, the CME 508 calculates an m/z error which may be the difference between the peak value and a theoretical m/z value for the composition. The CME 508 may also calculate a theoretical isotopic distribution, which is an intensity pattern for the theoretical peak value, and a fitting score, which may be a measure of fitness between observed and theoretical isotopic distributions for a particular composition.

As noted earlier, the extension module 504 includes a set operation engine (SOE) 510. The SOE 510 is configured to perform set operations (union, intersection, etc.) over multiple composition lists to identify the MSⁿ target ions. Certain glycans are more likely to be target ions if they are observed in both native and derivatized samples.

In certain embodiments, two or more samples from different genotypes, populations or treatment conditions are profiled and spectral data are compared to locate differences. In such embodiments, typically, the difference of multiple samples is in the ions relative abundance patterns. The extension module 504 includes a biomarker discovery engine (BDE) 512. BDE 512 is configured to perform statistical analysis on different carbohydrate profiles to prompt the ions with statistically significant difference for further analysis.

In certain embodiments, the functions of the peak picking engine and the composition mapping engine can be using one or more of the following steps:

1. Set a range of permissible ion charge states (e.g., +1, +2, etc.). Such values may be based on a predetermined set of permissible charges, or may be determined by an operator prior to analyzing a particular sample.

2. Optionally perform baseline correction of the mass spectrographic data if necessary (for instance, while working with MALDI data).

3. Identify the peaks (local maxima) in the mass spectral data.

4. For each peak above an intensity threshold (which may be predetermined or set based on evaluation of the mass spectrographic data):
a) Using each permissible ion charge state, propose a mass for the current peak (which itself represents a mass/charge ratio), and identify associated isotopic peaks (e.g., peaks whose mass/charge ratio (using the current ion charge state value) correspond to integer increases or decreases of the proposed mass);
b) If all expected associated isotopic peaks are found for a proposed mass, add the proposed mass to a set of validated peak masses, and optionally record the associated isotopic distribution (e.g., the relative intensities of the various associated isotopic peaks).

5. For each validated peak:
a) Generate all simple and compound ion forms to be considered and calculate corresponding normalized masses;
b) Use the Composition Mapping Engine (CME) to assign proposed compositions, e.g., using normalized masses;
c) For each proposed composition assignment:
   i. Calculate m/z error (difference between observed m/z and theoretical m/z for the elemental composition of the proposed composition);
   ii. Optionally generate a theoretical isotopic distribution (e.g., based on relative abundance of isotopes of each element) and evaluate fit with recorded data;
   iii. Add composition and supporting evidence to a set of proposed compositions.

6. Optionally use Set Operation Engine (SOE) and/or Biomarker Discovery Engine (BDE) to further analyze data (e.g., if working with multiple mass spectrographic profiles).

The spectrum screener 106 includes a daemon 514. The daemon 514 includes a client application configured and designed to automate the submission of spectral data files to the spectrum screener 106. In certain embodiments, the daemon 514 includes a batch mode in which files are identified for submission and a real-time monitor mode, in which new files on a pre-defined path are submitted as they are created. One or more screening parameters are further specified by users (or otherwise predetermined) and saved in XML files as metadata for the daemon 514. The spectrum screener 106 may also include a GUI 516 for providing an intuitive interface to end users.

Returning to FIG. 1, the sequencing system 100 includes a fragment library 112. The fragment library 112 is a database having mass spectral data along with corresponding carbohydrate fragment information.

FIG. 6 is a block diagram depicting the fragment library system 112 of FIG. 1 according to an illustrative embodiment of the invention. The library system 112 includes a selected standard set of carbohydrates 602, a reference carbohydrate MSⁿ spectra set 604 and a fragment library database 606. The system 112 also includes a MS search tool 608, a web interface 610, and other data mining tools 612.

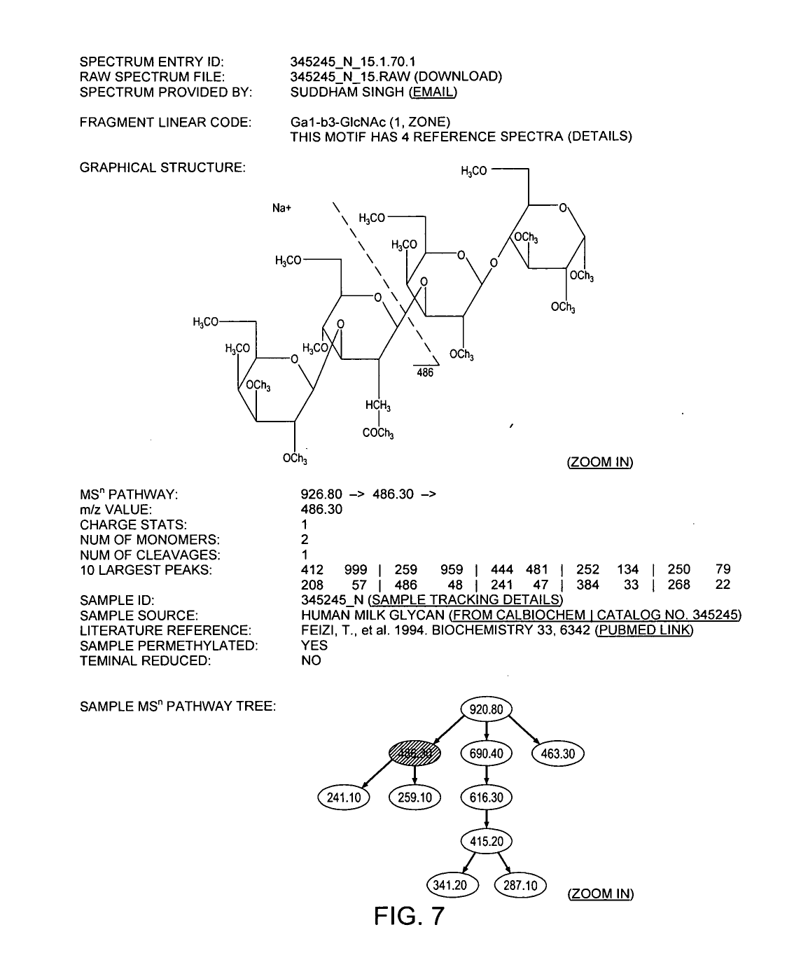

In one embodiment, MSⁿ standard spectra are from methylated glycans obtained from pure oligosaccharide standards or from previously well-characterized samples. The spectra from MSn pathways are obtained as provisional library records. Curation is the process of “housekeeping” efforts related to the library collection, including structural annotation of the ion fragment spectra, relevant information documentation, data cleanup, data preparation, and loading. During curation, structural assignment of the fragment spectra is confirmed. All library 112 data are stored in one centralized relational database 606, which provides efficient data management and flexibility for further data mining. The database 606 records can be exported in various data formats including NIST-MSP and XML enabling data exchange with third party tools. For instance, the library records can be exported as a batch to the NIST MS search tool, which provides an MS spectral search engine with proven sensitivity and specificity. Driven by scripts, the system's 112 web interface 610 displays data stored in the central database 606 and allows users to query, explore, and retrieve library records from multiple entry points. One typical fragment library 112 record page is illustrated in FIG. 7. An MSn disassembly tree is provided to visualize the hierarchical relationship among all the spectra, allowing the user to explore the data set. Related data including raw spectrum files, structural assignment (linear code and graphical representation), sample identification number, sample source, provider, and literature reference are accessible from the page.

In certain embodiments, isobaric oligosaccharide substructures may generate distinct fragments in Collision Induced Disassociation (CID) spectra or may generate isobaric fragments differing only in the ion intensity patterns, indicating underlying structural or stereochemical differences. Therefore, spectral matching can be used for oligosaccharide substructure confirmation.

In certain embodiments, the library collection coverage is not limited to manually curated standard glycan fragments MSⁿ spectra any more, but expands to include all raw MSⁿ spectra obtained from any known carbohydrate samples during operation of the system. The structural identities of those raw spectra are annotated by automated software tools. Annotated spectra are stored as reference entries in fragment library database 608. Unknown spectra/fragment identification is achieved by clustering-based spectral comparison with library reference entries.

In certain embodiments, the fragment library 112 includes one or more components designed to automate raw spectra data extraction, processing, archiving, curation, metadata inputs and spectra/structure data management.

In other embodiments the library 112 includes an automated fragment annotation system to annotate raw MSⁿ fragments/spectra obtained from known samples automatically. In one embodiment, the AFAS assigns structures to observed MSⁿ reference spectra using the method outlined as follows. To determine a glycan fragment observed during the MSⁿ disassembly of one known glycan, AFAS requires the following inputs: (1) the parent glycan structure; (2) the MSⁿ disassembly pathway; and (3) the glycan fragment mass. AFAS firstly generates all possible fragment structures from the parent structure matching the fragment mass; then it applies the MSn pathway constrains to eliminate candidates which do not fit; finally, AFAS returns the remaining fragment structure(s) as the annotation assignment. AFAS is particularly superior to manual annotation when there are multiple possible interpretations of the pathways. Annotations generated in silico using AFAS will be validated by human experts to ensure annotation quality. Since the human validation will lag behind the AFAS processing, different level of annotation confidence will be given to each library 112 reference entry.

In still other embodiments, the library 112 includes a spectrum-clustering approach designed for glycan fragment identification. The spectrum-clustering approach may be designed and applied for any carbohydrate fragment identification without departing from the scope of the invention. The search engine is used to assign fragment structures given observed spectra. In one embodiment, we begin with two sets of spectra: (A) the fragment library 112 reference spectra and (B) the unknown query spectra. The spectra from (A) and (B) are combined, analyzed for similarities, and grouped into clusters. Then, for each query spectrum, we assign an annotation based upon the spectra from (A) that are in the query spectrum's cluster. This approach typically depends on a group of reference records (a cluster), rather than a single record (a spectrum). This may make assignments more robust even in the face of occasional annotation errors. Another benefit of this approach is the potential to handle glycan mixtures: If the query spectrum does not fit in any cluster, then it either represents a new fragment or is a mixture of multiple fragments. The mixture hypothesis can be tested by comparing the query spectrum against a series of simulated spectra representing incremental mixtures of two standards. The mixture composition may be determined by finding the mixture ratio which maximizes the comparison similarity.

In certain embodiments, the fragment library system 112 presents a substantial improvement on library building speed and reference entries size. The fragment library 112 helps relieve human experts from manually annotating data. The fragment library 112 also helps maintain a balance between accuracy (quality) and efficiency (quantity) during library curation and building steps. The fragment library 112 including the tools for library building, fragment annotation and clustering-based searching, as described above, in combination with one or more components of the sequencing system 100 helps provide a basis for a fully integrated high-throughput sequencing platform.

As noted above, a clustered fragment library can be used advantageously in combination with any system for sequencing carbohydrates, e.g., for sequencing, annotating, deducing structure and searching carbohydrates. A clustered fragment library may be used in combination with any system for searching or annotating or deducing the structure of carbohydrates. In certain alternative embodiments, a clustered fragment library may be a modular component capable of interfacing with users and/or processors for performing various functions including searching, annotating, sequencing, or deducing of structural information, or any combination of these.

The fragment library 112 may be linked with the control module 114 and topology processor 110 of FIG. 1. The fragment library 112 is capable of sharing its information with the topology processor 110 for improved sequencing, and the topology processor 110 shares its sequence information to confirm and update the library 112. In addition to the components described thus far, the sequencing system 100 also includes automated data acquisition techniques for more efficiently acquiring and parsing information from one or more mass spectrometers.

Many mass spectrometers are capable of automated data acquisition, where the analyst typically defines ions and neutral losses of interest, and the instrument dutifully collects sets of mass spectra for ions that meet these constraints. However, these capabilities are currently quite limited and often result in the collection of many redundant or useless spectra.

Even the best commercially-available data acquisition software is insufficient for collecting spectra for oligosaccharide analysis. For example, the existing ThermoFinnigan automated data acquisition capabilities often collect redundant or uninformative spectra. They also fail to capture the broad range of structurally informative spectra needed to make confident structural assignments. The existing methods also have limitations when making the transition from a multiple-charged precursor ion to a lesser-charge product ion, or when attempting to analyze the complementary fragments generated by a single glycosidic cleavage.

In certain aspects, the sequencing system 100 including controlling module 114 helps drive the MSⁿ data acquisition process, instructing the mass spectrometer to fragment only ions of interest. Data acquisition proceeds without time-consuming, error-prone human oversight, and yields high-quality, structurally informative spectra well suited for further high-throughput analysis by the sequencing system 100.

ThermoFinnigan has released software that allows an external computer program (the “client”) to communicate with the instrument's data acquisition software in real-time. The client is notified when a new mass spectrum had been acquired. The client then examines the ions contained in the spectrum and decides which, if any, should be the precursor ion selected for the next round of MSⁿ.

In one embodiment, the sequencing system 100 includes peak-picking software similar to a peak-picking engine (PPE). PPE may use heuristics such as one or more of the following to guide peak selection.

1. PPE may select ions produced from the rupture of glycosidic bonds, ignoring cross-ring fragments until the underlying topology has been established. PPE may also initially focus on high-intensity ions and generate successive fragmentations to collect deep (high-order) MSⁿ probes of the glycan.

2. PPE may search for the complementary fragments generated by a single glycosidic cleavage. That is, when a precursor ion fragments to form products P1 and P2, where P1 and P2 sum to match the precursor, further MSn fragmentation of P1 and P2 is warranted. If the mass of the precursor ion is known, then the mass of P1 can be determined from a known mass of P2 and vice versa. PPE recognizes complementary product ions and schedules both ions for further fragmentation.

3. After initial spectra are collected, PPE has a number of spectra it can use as input to the IsoSolve algorithm. IsoSolve may use these spectra to attempt to assign structures. If a single structure is identified, PPE may use IsoDetect to discover observed ions that are inconsistent with the proposed structure. These ions now become candidates for fragmentation.

4. PPE may hunt for particular ions to reduce the uncertainty reflected in the constraint algorithm's 302 data structures 304 and 306. Consider the glycan in the figure shown below, and assume that the parent/child relationship of the F/N branch is currently unresolved.

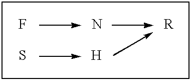

This is clear to the constraint algorithm 302, as every mono would know exactly what its parent was, except for F and N. (F would have N and R as possible parents; N would have F and R.) To resolve this uncertainty, the constraint algorithm 302 searches the generated spectra for an ion matching the composition FH-(oh) or FH-(ene), and selects that ion for fragmentation. The resulting spectrum will clearly indicate that F is the leaf and N in the internal residue.

5. PPE may also collect the spectra that are most likely to be useful for library matching with the fragment library 112 or that reveal cross-ring fragments suitable for assigning interresidue linkages.

FIG. 9 depicts a system 900 for sequencing carbohydrates according to one illustrative embodiment of the invention. In particular, the system 900 includes components similar to sequencing system 100 of FIG. 1, such as processor unit 902 including the spectrum screener 106, topology processor 110 and fragment library 112. In addition, system 900 includes systems and methods that operate in conjunction with the processor unit 902 to automate the process of sequencing carbohydrates, identifying new carbohydrate compositions and structures and acquiring data from a mass spectrometer 104. System 900 includes an isomer detector 904 for identifying pathways in MSⁿ raw spectral data that are explained by currently or previously sequenced and known carbohydrate structures. The isomer detector 904 may be used to detect unknown pathways that will then lead to the discovery of previously unknown carbohydrates structures and/or isomers. System 900 also includes an isomer solver 906 for determining the structure of isomers that may exist in complex samples in the sample pool 102. The system 900 further includes an intelligent data acquisition processor (IDA) 908 that connects to the mass spectrometer 104 and automatically monitors and controls the sequential fragmentation of the carbohydrate.

In one embodiment, isomer detector 904 accepts (1) a list of carbohydrate structures expected at a given mass and (2) a set of raw mass spectral data files, and automatically extracts all structurally-informative fragmentation pathways from the files. It then uses the constraint algorithm 302 to determine which of those pathways could have come from the expected carbohydrate.

The isomer detector 904 helps prepare a detailed accounting of which pathways are compatible or consistent with which expected structures, and helps select a list of fragmentation pathways that appear to have come from an unknown structure, which may mean that unreported isobaric structures are present. (Isobaric structures have the same mass but different internal structures, e.g., the structures are isomeric.)

In certain embodiments, during operation, the isomer detector 904:

1. extracts all or substantially all structurally informative fragmentation pathways from the data files and places them into a pathway set;

2. accepts as input a representation (such as a textual representation) of the structures expected to be found in this data set;

3. for each pathway P in the set:
a. for each expected structure S:
   i. create a data structure that exactly represents the structure. (That is, create the monosaccharide data structures 304 so that each monosaccharide is connected to the correct parent and children, at the correct linkage positions.)
   ii. add the pathway P to a list of compositions.
   iii. have the processor unit 902 evaluate the list of compositions. If the list of compositions still produces the expected structure S, then pathway P is considered to be consistent with the structure. Otherwise, the pathway is considered to be inconsistent with the structure.; and

4. Report results:
a. For each expected structure, report which pathways are consistent with it and which are inconsistent,
b. For each pathway, report the list of structures with which it is consistent,
c. Report the pathways that are inconsistent with all expected structures.

The output from step 4a gathers all supporting evidence for each structure in one place, making it easy to gauge how much evidence is present for each structure. Step 4b gives some idea of how many pathways are compatible with multiple structures and which are compatible with only one structure.

However, the output from 4c is typically valuable to the analyst. It lists all structurally plausible fragmentation pathways that are incompatible with all expected structures. As such, the pathways may hint at new, unreported isobaric structures. These pathways allow the analyst to focus his or her attention on the search for unreported structures.

The sequencing system 900 includes an isomer solver 906 for finding sets of fragmentation pathways that combine to uniquely assign a structure. In certain embodiments, the isomer solver 906 is configured with automated processes for searching a pathway combination space. The isomer solver 906 creates a candidate initially represented by a single fragmentation pathway; the processor unit 902 (topology processor 110, spectrum screener 106 and fragment library 112) is used to generate all, or substantially all, structures compatible with this pathway; then the isomer solver 906 attempts to find combinations of pathways that uniquely describe each of these proposed structures.

In one embodiment, during operation, the isomer solver 906:

1. is given a set of raw spectral files and a mass for the intact carbohydrate, and extracts all structurally informative fragmentation pathways from the data files;

2. marks all pathways as “unexplained;”

3. for each pathway, the isomer solver 906 generates an upper bound on the number of branching topologies with which this pathway could be consistent (a smaller number may represent a pathway that is more structurally informative);

4. sorts the pathways in order from most structurally informative to least.

5. selects the most informative unexplained pathway P;
a. creates a candidate that initially contains the single pathway P,
b. uses the processor unit 902 (topology processor 110, spectrum screener 106 and fragment library 112) generate all structures compatible with the candidate, put these into the Found Carbohydrate Pool, and mark them all as “unproven”.
c. selects the next pathway from the sorted pathway list and tentatively adds it to the candidate,
d. re-evaluates the candidate by using the processor unit 902. If it produces zero structures, then some combination of pathways must be incompatible, and the newly-added pathway is removed. If it produces the same number of structures as before adding the new pathway, then the new pathway was not helpful, so it is removed. If the candidate now produces fewer structures than before, but still more than one structure, the new pathway was useful but the algorithm is not done yet. Keep it and go to step c.
e. Otherwise, the candidate now produces exactly one structure. This structure is marked in the Found Carbohydrate Pool as “proven”. Next, the entire set of pathways is reviewed. If an “unexplained” pathway is found to be compatible with this new carbohydrate (that is, if some sequential fragmentation of the carbohydrate could yield the pathway), it is marked as “explained.”
f. If some carbohydrate in the Found Carbohydrate Pool is still unmarked, continue from step 5a and attempt to find a combination of pathways that uniquely specifies that structure.

6. Now that the isomer detector 906 has attempted to prove all structures in the Found Carbohydrate Pool, many of the pathways have been marked as “explained”. Continue with step 5 until all unexplained pathways have been used.

7. Report the structures that were marked as proven. For each structure, list the set of pathways that cause the processor unit 902 (topology processor 110, spectrum screener 106 and fragment library 112) to produce only the proven structure.

To summarize the above algorithm more succinctly, but less formally:

a) Each unexplained pathway (“seed” pathway) is used to generate a set of structures.

b) The isomer solver 906 performs an exhaustive search of the pathway combination space, attempting to find a combination that, when given to the processor unit 902, produces exactly one structure, which is then marked as proven. Note that the seed pathway is typically part of the combination.

c) As structures are proven, compatible pathways are marked as explained. This avoids using a pathway as a seed for the search when a compatible structure has been proven.

The sequence system 900 also includes an intelligent data acquisition processor (IDA) 908 that given a set of raw spectral data, may be configured to automatically select ions (or peaks on a mass spectrum) that may be worthy of further fragmentation. In one embodiment, the IDA 908 automatically selects a variety of peaks useful for making structural determinations of a carbohydrate sequence. In another embodiment, the IDA 908 selects the highest or a relevant peak(s) having a high intensity that could have resulted from glycosidic cleavages, for each round of mass spectrometry. The selected ion may then be further fragmented in subsequent rounds based on similar criteria to traverse a deep MSn pathway. In another embodiment, the IDA 908 selects peaks or ions that are complementary to an existing spectrum's pathway so that lost complementary fragments may be identified and isolated. In yet another embodiment, the IDA 908 may interact with one or more of the isomer solver 906 and isomer detector 904 at least for automatically detecting and automatically sequencing isomers. For example, the IDA 908 may select peaks that the isomer detector 904 flags as indicating possible isomers.

In certain embodiments, the IDA 908 may select peaks that have compositions where the reducing end and/or the non-reducing end of the carbohydrate is scarred so as to isolate losses on one or more ends of the carbohydrate or fragment. In other embodiments, the IDA 908 selects peaks that have a composition containing at least one (ene)-type scar.

In certain embodiments, the IDA 908 may facilitate automated data acquisition by using any one or more of several inquiry modes to identify, propose, and/or select ions that are worthy of further fragmentation. Exemplary modes for selecting ions for further fragmentation include:

A) MissingComplements: identifies lost complementary fragments.

B) OnlyReducingEndScarred: identifies all losses on reducing end of fragment.

C) OnlyNonReducingEndScarred: identifies all losses on nonreducing end of fragment.

D) SingleSideScarred: selects ions that satisfy either OnlyReducingEndScarred or OnlyNonReducingEndScarred.

E) EneScar: identifies B-type (pyranosylene) ions likely to produce structurally informative cross-ring fragments.

The IDA 908 may also implement a pruning feature to the data acquisition process. Various collection modes, including modes A-E shown above, may collect more data than necessary. The software therefore can “prune” or omit spectra that would have been collected but are unlikely to provide any new structural information, thereby reducing dependence on the mass spectrometer and reducing data collection time. Tables 59 and 60 in Lapadula PhD Thesis show an example of the difference between the number of spectra collected without and with spectrum pruning, respectively. The additional spectra found in Table 59 contribute little or no useful information beyond that present in the spectra of Table 60. Pruning in this case succeeds in rejecting structurally uninformative spectra, reducing data collection time.

In certain alternative embodiments, the sequencing system 900 includes on or more processors and/or processes to make a carbohydrate structural assignment by proposing a set of random carbohydrate structures and evaluating how well each structure matches the available fragmentation pathways. The best candidate structures are mutated and the process is repeated until a user-selectable number of generations have been evaluated. Then the best candidates are presented to the analyst as tentative structural assignments. Such a technique is similar in certain respects to a stochastic beam search.

In one embodiment, the process accepts several user-defined (or otherwise predetermined) parameters: M, the mass of the target carbohydrate(s); I, the cutoff intensity below which MSⁿ data peaks are ignored; W, indicating the width of the search beam; N, the number of structures the analyst would like to be proposed; and a set of raw MSⁿ spectral data files. The structure-proposing process can also accept an optional set of expected structures that the analyst suspects are present. These structures are then flagged in the final output, if they were in fact found by the algorithm.

In certain embodiments, during operation, these additional components of system 900:

1. generates W random proposed carbohydrates with mass M

2. assigns each proposed carbohydrate a score that quantifies how much MSⁿ data is consistent with it (See Section 7.2.)

3. runs one round of the beam search:
a. for each proposed carbohydrate, create a “subtree mutant” and “swapped-mono mutant” and place into a pool
b. place the (unmutated) carbohydrate itself into the pool
c. sort the pool by score
d. select the W best candidates and move into the next generation
e. if no improvement is shown for five successive generations, terminate the round and report the proposed carbohydrate(s) with the highest score. Improvement is measured strictly by the highest-scoring candidate in the generation. More than one proposed carbohydrate can be reported in the case of ties.

4. If the process has not yet reported N structures, repeat from step (1).

In certain embodiments, a candidate structure's score is the sum of the score assigned to each of its compatible pathways. The process allows the user to select from four different scoring functions (the kProp names come from the C++ source code):

kPropScoreEqual: Each pathway has a score of one. This yields a candidate score equal to the number of pathways consistent with the candidate.

kPropScoreNumlons: If the pathway contains N ions, its score is N−1. This gives a higher score for deeper MSⁿ disassembly pathways. One is subtracted from this number because every proposed glycan is guaranteed to match the root ion, and so no credit should be given for that one ion.

kPropScorelntensity: The score is the relative intensity (0-100) of pathway's terminal ion. This gives more weight to intense ions, keeping less-intense peaks from overly dictating the outcome.

kPropScoreNumIonsTimesIntensity: The score is the product of the intensity and (depth-1). This gives more weight to the deeper, more intense pathways.

Many beam searches operate by keeping a set of candidates, mutating them in some way to create a pool of candidates, and then promoting the fittest (highest-scoring) candidates into the next generation. Recall that carbohydrates naturally have a tree structure and therefore the mutations supported must be tree operators.

Suppose that one or more components of system 900 has generated the glycan shown below during the beam search. The “swapped-monos” mutation chooses two monos at random and swaps them, leaving the structure of the tree unchanged but the identities of the two monos exchanged.

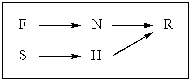

### A Sample Proposed Glycan

The figures below shows the resulting glycan if the F and H monos are swapped.

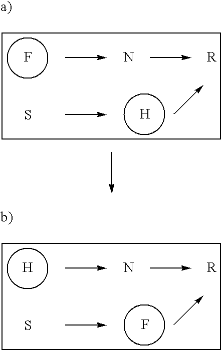

The same proposed glycan before and after a “swapped-monos” mutation. In (a), the F and H monos have randomly been selected and in (b) they have been swapped.

The swapped-monos mutation allows for rearrangements within a glycan structure, in contrast with the subtree mutation described next. A second mutation operator is called a subtree mutation because it relocates an entire subtree within the glycan.

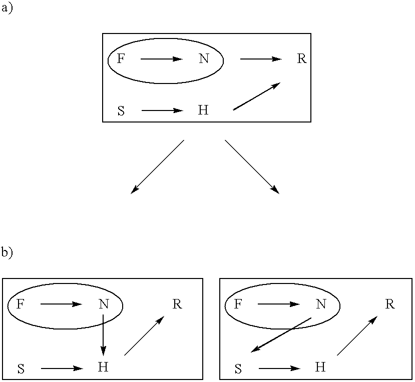

The proposed glycan is shown again in (a), with the F/N subtree selected for mutation; (b) shows the two possible mutants, where N has been given a new parent mono.

Consider “a”, in which the F/N subtree has been randomly selected to be moved. In this example, there are exactly two monos which can serve as the new parent of the N mono: H and S. R is ineligible because it is already the parent of N, and F is ineligible because it is part of N's subtree.

The processes described herein may be executed on a conventional data processing platform such as an IBM PC-compatible computer running the Windows operating systems, a SUN workstation running a UNIX operating system or another equivalent personal computer or workstation. Alternatively, the data processing system may comprise a dedicated processing system that includes an embedded programmable data processing unit. For example, the data processing system may comprise a single board computer system that has been integrated into a system for performing micro-array analysis.

The process described herein may also be realized as a software component operating on a conventional data processing system such as a UNIX workstation. In such an embodiment, the process may be implemented as a computer program written in any of several languages well-known to those of ordinary skill in the art, such as (but not limited to) C, C++, FORTRAN, Java or BASIC. The process may also be executed on commonly available clusters of processors, such as Western Scientific Linux clusters, which are able to allow parallel execution of all or some of the steps in the present process.

As noted above, the order in which the steps of the present method are performed is purely illustrative in nature. In fact, the steps can be performed in any order or in parallel, unless otherwise indicated by the present disclosure.

The systems and methods of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

### Exemplification

Methods and Sample Preparation. Maltose, maltotriose, panose, globotriose, and Gal-α(1-4)-Gal were purchased from Sigma (St. Louis, Mo.). Cellotriose, liner B2 trisaccharide, (Gal-α(1-3)-Gal-β(1-4)-GlcNAc), lacto-N-tetraose, lacto-N-neotetraose, and lacto-N-fucopentaose I were purchased from Calbiochem (EMD Biosciences, Inc., La Jolla, Calif.). Nigerotriose and laminaritriose were purchased from V-Labs, Inc. (Covington, La.). Selected oligosaccharides were reduced with NaBH₄ (10 mg/mL, dissolved in 0.01 M NaOH) and left overnight at room temperature. The reduction solution was chilled, terminated by the addition of glacial acetic acid, and diluted with 3 mL of ethanol before drying under a nitrogen stream. Borate esters were removed by repeated addition and drying of a 1% acetic acid methanol solution. Three milliliters of toluene was added and evaporated three times. The dried samples were dissolved in water, desalted by passage through a column of Dowex 50W cation-exchange resin (Sigma-Aldrich, St. Louis, Mo.), and redried. Methylation was carried out according to the method of Ciucanu and Kerek (Carbohydr. Res. 1984, 131, 209). Briefly, the samples were dissolved in DMSO (HPLC grade, Sigma-Aldrich), followed by addition of powdered sodium hydroxide (99.999%, Sigma-Aldrich). After vortexing to produce a suspension, iodomethane (99.5%, Sigma-Aldrich) was added. The reaction tube was then vortexed for 1 h to allow the reaction to proceed. Afterward, water was added to stop the reaction. Permethylated oligosaccharides were extracted three times with dichloromethane (HPLC grade, EMD Biosciences, Inc.). The extracts were combined and washed three times with MilliQ water (Millipore Corp., Billerica, Mass.). The dichloromethane was evaporated under nitrogen stream. Native (unmethylated) and methylated samples were dissolved in methanol/water (1:1, containing 1 mM sodium acetate) for mass spectrometry. Mass spectrometry experiments were carried out on a linear ion trap mass spectrometer (LTQ, ThermoFinnigan, San Jose, Calif.) using a nanoelectrospray source, 0.40-0.60 μL/min flow rate at 200-230° C. capillary temperature in positive ion mode with 30-50% collision energy. Selected studies were also carried out by MALDI-QIT-TOF (Axima-QIT, Kratos Shimadzu, Manchester, UK), using dihydroxybenzoic acid as a matrix. Collision energies were set to leave a small but detectible abundance of the precursor ion. Activation Q and activation time were left at their default values, 0.25 and 30 ms, respectively, for all MSⁿ experiments. In our experience, changing collision energy will affect the relative abundance of precursor ion, but generally does not change the relative product ion abundances. Changing the activation Q or activation time can affect relative product ion abundances and so were kept constant. All ions were sodium adducts, except where noted.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

1. A method for determining structural information about an oligosaccharide, comprising:
providing a set of one or more monosaccharide units that make up at least a portion of the oligosaccharide;
populating at least one data structure for the one or more monosaccharide units, wherein the at least one data structure includes at least one data field containing sequence information for the one or more monosaccharide units;
iteratively:
applying an inference rule to the set of one or more monosaccharide units, and
updating the at least one data structure by modifying the sequence information in the at least one data field based, at least in part, on an inference deduced from applying the inference rule,
determining structural information about the oligosaccharide from the updated data structure.

2. The method of claim 1, wherein providing a set of one or more monosaccharide units, comprises:
providing a first mass spectral data set obtained from profiling a sample comprising the oligosaccharide in a mass spectrometer,
selecting a first ion mass from the first mass spectral data set, and
mapping the first ion mass to a first set of one or more monosaccharide units, wherein the combined mass of the monosaccharide units in the first set when joined together is consistent with the first ion mass.

3. The method of claim 2, further comprising:
providing a second mass spectral data set obtained from profiling an ion indicated in the first mass spectral data set in a mass spectrometer,
selecting a second ion mass from the second mass spectral data set, and
mapping the second ion to a second set of one or more monosaccharide units, wherein the combined mass of the monosaccharide units in the first set when joined together is consistent with the second ion mass.

4. The method of claim 3, further comprising comparing the second set of one or more monosaccharide units with the first set of one or more monosaccharide units to determine whether all monosaccharide units in the second set are also present in the first set.

5. The method of claim 3, further comprising storing in memory both the first ion mass and the second ion mass.

6. The method of claim 4, further comprising discarding the second set if it includes monosaccharide units not present in the first set.

7. The method of claim 1, wherein providing a set of one or more monosaccharide units comprises:
providing a plurality of mass spectral data sets obtained from profiling the oligosaccharide in a mass spectrometer and iteratively profiling individual ions detected during profiling, such that in each iteration a fragment of the oligosaccharide is individually profiled,
selecting a plurality of ion masses from the mass spectral data sets, and
mapping each ion mass to a set of one or more monosaccharide units, wherein the combined mass of the monosaccharide units when joined to form an oligosaccharide is consistent with the corresponding ion mass of the oligosaccharide.

8. The method of claim 7, further comprising storing in memory the ion mass for each iteration.

9. The method of claim 1, wherein providing a set of one or more monosaccharide units comprises:
providing a plurality of mass spectral data sets obtained from iteratively profiling the oligosaccharide in a mass spectrometer, such that in each iteration a fragment of the oligosaccharide is individually profiled,
selecting a plurality of ion masses from the mass spectral data sets, and
storing in memory the plurality of ion masses,
selecting a fragmentation pathway having a plurality of ion masses from successive iterations,
mapping each ion mass on the fragmentation pathway to a set of one or more monosaccharide units.

10. The method of claim 9, further comprising selecting a second fragmentation pathway having a plurality of ion masses from a second set of successive iterations.

11. The method of claim 9, wherein selecting a fragmentation pathway includes randomly selecting a fragmentation pathway.

12. A system for obtaining information useful for sequencing oligosaccharides, comprising;
a spectrum screener, including:
a peak picking engine for selecting an ion mass from mass spectral data obtained from profiling an oligosaccharide sample in a mass spectrometer, and
a composition mapping engine for mapping the ion mass to a set of one or more
monosaccharide units, wherein the combined mass of the monosaccharide units when joined to form an oligosaccharide is consistent with the corresponding ion mass of the oligosaccharide;
a topology processor capable of receiving the set of one or more monosaccharide units, the topology processor comprising:
at least one data structure having at least one data field containing sequence information for one or more monosaccharide units from the set of one or more monosaccharide units,
an inference database including at least one inference rule, and
a constraint algorithm module for applying the at least one inference rule to the set of one or more monosaccharide units and updating the at least one data structure;
wherein the at least one data structure includes information useful for sequencing oligosaccharides.

13. The system of claim 12, further comprising a control module for operating at least one of the topology processor and the spectrum screener.

14. The system of claim 12, further comprising a fragment library including sequence information for one or more fragments of one or more previously characterized samples.

15. The system of claim 12, wherein the sample includes an oligosaccharide.

16. The system of claim 15, wherein the oligosaccharide includes a glycan.

17. The system of claim 12, further comprising an algorithm module, cooperating with the constraint algorithm module, for applying a genetic algorithm technique to sequence an oligosaccharide.

18. A computer system for use in determining structural information about an oligosaccharide, comprising computer instructions for:
providing a set of one or more monosaccharide units that make up at least a portion of the oligosaccharide;
populating at least one data structure for the one or more monosaccharide units, wherein the at least one data structure includes at least one data field containing sequence information for the one or more monosaccharides;
iteratively:
applying an inference rule to the one or more monosaccharide units, and
updating the at least one data structure by modifying the sequence information in the at least one data field based, at least in part, on an inference deduced from applying the inference rule; and
determining structural information about the oligosaccharide from the updated data structure, or
a computer-readable medium storing a computer program executable by a plurality of server computers, the computer program comprising computer instructions for:
providing a set of one or more monosaccharide units that make up at least a portion of the oligosaccharide;
populating at least one data structure for the one or more monosaccharide units, wherein the at least one data structure includes at least one data field containing sequence information for the one or more monosaccharide units;
iteratively:
applying an inference rule to the set of one or more monosaccharide units, and
updating the at least one data structure by modifying the sequence information in the at least one data field based, at least in part, on an inference deduced from applying the inference rule; and
determining structural information about the oligosaccharide from the updated data structure.

19. A method for resolving the structure of an oligosaccharide, comprising:
receiving a plurality of sets of mass spectral data obtained from sequential mass spectrometry of an oligosaccharide;
automatically selecting one or more fragmentation pathways from the plurality of sets of mass spectral data, each fragmentation pathway having a set of ion masses corresponding to fragments of the oligosaccharide;
identifying one or more monosaccharide units that make up at least a portion of the oligosaccharide from the one or more fragmentation pathways; and
resolving a structure of the oligosaccharide by iteratively applying one or more inference rules to the one or more monosaccharide units to refine a structural relationship between the one or more monosaccharide units.

20. The method of claim 19, wherein automatically selecting one or more fragmentation pathways includes selecting one or more fragmentation pathways that do not correspond to an resolved oligosaccharide structure.

21. The method of claim 19, wherein automatically selecting one or more fragmentation pathways includes randomly selecting one or more fragmentation pathways.

22. A method of detecting the presence of isomers of an oligosaccharide in a sample, comprising:
receiving a plurality of sets of mass spectral data obtained from sequential mass spectrometry of the sample;
receiving a set of expected oligosaccharides, each having sequence information;
selecting a first set of fragmentation pathways from the plurality of sets of mass spectral data, each fragmentation pathway in the first set having ion masses corresponding to fragments of an oligosaccharide in the sample;
generating a second set of fragmentation pathways, from the first set, that are consistent with the set of expected oligosaccharides such that fragmentation of each of the set of expected oligosaccharides occurs along at least one of the fragmentation pathways in the second set; and
detecting the presence of isomers based on the existence of fragmentation pathways in the first set that are not in the second set; or
a method of resolving the structure of an oligosaccharide, comprising:
performing sequential mass spectrometry of an oligosaccharide, including
generating a set of mass spectral data for a fragmentation step,
automatically selecting an ion mass in the set of mass spectral data, and
performing further fragmentations of the selected ion mass;
generating a fragmentation pathway having ion masses corresponding to ion masses of successive fragments of the oligosaccharide; and
resolving a structure of the oligosaccharide by iteratively applying one or more inference rules to the fragments along the fragmentation pathway;
wherein automatically selecting an ion mass includes selecting an ion mass based at least on its intensity in the mass spectral data and at least one of an associated type of fragmentation and elemental composition of the oligosaccharide.
